(19) United States
(12) Patent Application Publication
(10) Pub. No.: US 2006/0116918 A1
(43) Pub. Date: Jun. 1, 2006

(54) Network scheduler with linked information

(76) Inventors: Joel L. Flora, Columbus, OH (US); William P. Messerly, Westerville, OH (US); Krista A. Ruoff, Orient, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/000,610

(22) Filed: Dec. 1, 2004

(51) Int. Cl. G06F 9/46

(52) U.S. Cl. 705/8; 705/9

(57) ABSTRACT

A system and method of scheduling events offered and or created by one or more sales target having a network association with one or more rep and linking information to the event.

### FIELD OF THE INVENTION

The present invention relates to access to information in a network and electronic allocation of time for meetings and scheduling, specifically, an information-sharing method integrated with a calendaring method in which a predetermined number of users may offer and or accept scheduled interactions and or appointments designated in a variety of ways and review associated information posted by the users electronically via a computer and or a digital viewing device with a connection to the network.

### BACKGROUND OF THE INVENTION

Representatives (rep(s)) of companies making calls on customers (sales target(s)), are a source of information about products/services and related support. Due to the limited time in a sales target's daily schedule and the volume of new products and new data reaching the marketplace each year, a sales target's ability to see each rep seeking his/her time, is typically inadequate. The time that a sales target may be able to spend with a rep may only consist of a few minutes between meetings or appointments. Consequently, many reps appear unannounced at a sales target's office, only to be turned away or spend hours waiting to see the sales target for a snippet of time that more than likely will be entirely too short or too frequently interrupted to be of value to either the sales target or the rep.

Reps and sales targets occur in every industry. In the healthcare industry, pharmaceutical reps provide information about new drugs, new indications, and clinical experience with prescription and over-the-counter medicines to a variety of sales targets including physicians and allied healthcare professionals who then act upon and or share this information with their patients. Drug reps are also a primary link to product samples. Further, hospitals and other healthcare facilities rely upon various reps for a variety of supplies and resource support.

A need exists in tight selling spaces for more efficient and effective contact between reps and sales targets. This need is greatest in industries such as the healthcare industry where sales targets (healthcare professionals) influence product/service utilization by large numbers of end-user targets (patients).

Many industries are becoming increasingly competitive and companies are challenged to promote more products to sales targets that have less time to learn about them. Many businesses must also reduce operating expenses in order to keep profits up. A method and system enabling a sales target or a rep to obtain information posted in a network by sales targets and or reps and to link this information with calendaring and scheduling functions for various events including recurring office visits, specially-requested appointment meetings, deliveries of product, samples and or support resources, and educational meetings and presentations with reps or sales targets, would improve the efficiency of sales target interaction with reps while increasing sales target and rep productivity and sales force cost-effectiveness. Increases in sales force productivity and cost-effectiveness would be important in the pharmaceutical industry, in that, with the possible exception of R&D, the sales force is a drug company's single largest operating expense item.

Information sharing is now easily achieved electronically, such as through a network. The Internet is a global network used to exchange information; however, with the growth of the Internet, finding information is sometimes a difficult and prolonged experience. Hyperlinks are a method used to assist users in finding information on the Internet by pointing and linking users to information located elsewhere. Hyperlinks typically appear embedded within information located at a given site or within an electronic message. By clicking on the hyperlink, a user is typically taken to the desired information location, which may be linked to the current site but located at a different location in the network, such as on a second server.

Online calendaring is a recent improvement for scheduling for all types of users. Online scheduling systems allow users to define meetings and recurrence patterns; allocate and or block time, personnel and resources for meetings; arrange, track, view, update, and refine individual and group meetings either in or out of a network. Many online calendars also allow a user to send messages to one or more other users; again, either in or out of a network. The message sender may be notified when a sent message has been received and or read by another user. Messages may contain embedded hyperlinks and the message sender may be notified when a user has used one or more hyperlinks to execute a website connection.

E-detailing is a web-based and or network-based method used by marketers to expose sales targets to promotional and/or educational materials. In the pharmaceutical industry, marketers (pharmaceutical companies) expose sales targets (physicians) to products in order to promote the prescribing and utilization of a specific drug or healthcare product. E-detailing makes use of electronic information sharing and is conventionally accomplished via a password-protected website that a user accesses in accordance with specific directions supplied by a marketer or a rep. After logging in to access the site, the user reviews product and or related educational material in an interactive format and may order product, samples, and/or other materials.

Problems exist with e-detailing, however, because most companies place a high premium on the value of the personal relationships that reps have with sales targets. These relationships deteriorate without personal face-to-face interactions. Providing incentives of sufficient value to attract and sustain certain sales targets to participate in e-detailing is an additional problem in specific industries, such as the healthcare industry, because ethical guidelines and legal statutes often impose limits on the nature and value of items transferred without charge from companies to sales targets.

Digital receivers are a recent addition to information and image transfer via a network, such as the worldwide web. Digital receivers have the advantage of electronically transferring information and images to a user's location via the Internet without the requirement for a user to have a traditional computer, monitor, or Internet service provider. Digital receivers can also be flexibly sized and designed, enabling placement in a variety of areas, such as common areas trafficked by users such as sales targets and or customers of a sales target. Moreover, digital receivers are combinable with computer processing units to program and automate information delivery and refreshment at pre-set times. In the case of pharmaceutical sales and marketing, a digital receiver could be placed in a common area in a physician's office and programmed to automatically dial-in to a server at night to download the reps scheduled to visit that office on a given day, products, and or educational information. The receiver would alert physicians and support staffs to rep visits, product or service information and or information of personal interest as they view the receiver on a daily basis without the hassle of using a traditional computer.

Information sharing includes other types of devices, such as implantable micro-processing chips. Currently, implantable devices, such as the VeriChip, generally contain medically related information, but the scope of use of such a device is not restricted. An implanted device may be programmed with an endless variety of information about a person and could be used for wireless electronic communication with other devices and users.

There is a need for a centralized communications network system that would allow various types of sales targets (purchaser/consumer) and reps (seller/vendor) to create, utilize, modify, and terminate associations with other users in a network at will. Such a system would help a sales target and rep realize greater relationship value, and would make it easier for each to be more efficient and or effective in their performance. Such a system would offer a simple and convenient means for a time-pressed sales target to optimize the timing, frequency, manner, and number of contacts with one or more rep on a recurrent basis and or to access information, samples, coupons, and resources supplied by one or more rep. The system would further serve to reduce the amount of time wasted by a rep driving to see one or more sales target only to find that one or more sales target is not available to see a rep and or waiting for one or more sales target. Such a system would also help a sales target learn about new and or important products, services and or support resources with increased efficiency and individualized focus. A fully-integrated, seamless system would make it possible for a sales target to (a) post rep-related policies for online viewing; (b) allocate and stagger the timing of recurrent sales and service calls; (c) automate the scheduling of one or more interaction with one or more rep; (d) locate one or more company rep and or resource of specific interest quickly with minimal navigation via a single point of access; (e) issue an appointment invitation to one or more rep without using the telephone; (f) transmit a request to one or more rep electronically without disclosure of a sales target email address; and (g) provide timely feedback on the performance and value of a rep and or a company-provided resource with minimal expenditure of time or effort. A rep's organization could benefit from use of the system by (a) transferring the equity in the personal relationship between one or more rep and one or more sales target from sales call interaction to contact via online and offline media; and (b) acquiring selling activity data for one or more rep and one or more sales target.

Although applicable to any industry, such a system would be particularly useful in the healthcare industry for physicians and pharmaceutical sales reps. Most physician and other healthcare providers currently do not have a system to automate and or optimize the implementation of various methods being used to control the flow of reps, particularly drug reps, into their offices. Reps come and go with no real knowledge of the office workload or if a physician/healthcare decision-maker is even potentially going to be available for a quick sales pitch. Pharmaceutical reps often waste time in an office waiting to see a physician or other healthcare decision-maker and consequently miss opportune times to call on other sales targets. Reps often compete for lunch meetings and or other opportunities to meet with physicians and office staff. Such competition is generally managed and arbitrated by office staff. Reps typically do not have prior knowledge of the specific needs or issues that a physician or staff member would like the rep to deal with the next time he or she is going to be in a particular office.

### SUMMARY OF THE INVENTION

The present invention addresses these needs by offering a network system for automating and optimizing a variety of methods for managing in-person and or other types of contact and information exchange between one or more sales target and one or more rep when both have acted to create an association with the other via a network. The present invention provides a method and system by which scheduling transactions, product and service information, coupons, educational and other support resource offerings, related communications, and the like, can be classified, categorized, and directed to one or more specific individual sales target and or to one or more variably defined group of sales targets by a single rep or a rep in concert with one or more other rep. The present invention supports both print and electronic communication and offers users the ability to view and or hear information using a variety of technology-based platforms, including CPUs, digital image receivers, digital audio players, and the like. The present invention is optionally integrateable with conventional electronic calendar programs. The present invention is adaptable for future iterations of networking, electronic calendaring, portable data storage media, wireless transmission of data, digital image transfer, digital audio transfer, and the like. The present invention is flexibly designed to meet the diverse needs of users in a variety of industries, business situations, and work environments.

The present invention provides a method and system of electronically offering and accepting an event having digital information linked to the event. The system and method comprising a server having one or more computing component connected to a network and one or more sales target and one or more rep connected to the network. The sales target comprises computing means to archive, print, and retrieve information and is optionally connected to one or more related sales target through the network or through a second network. The sales target accesses the server through a security component, which compares security information supplied by the sales target to sales target information contained in a sales target file stored in a database located at the server. After access, the sales target inputs sales target information comprises general information and specific information. The sales target specific information includes but is not limited to policies, food preferences, guidelines, email messages, archived files of messages, information regarding dealings with one or more associated rep, and the like. The sales target information is updateable and stored in the sales target file. The sales target uses a search component to build a search to discover one or more rep and or one or more sales target connected to the network. The search is based on an identifier, such as a name, geographic location, demographic information, and the like.

In an embodiment, the sales target creates an association with one or more rep either through the search or by directly inputting the rep name. The sales target uses a scheduler component to offer, modify, confirm and or determine a status of an event. The events are electronically linked to sales target information. The events are categorized as interactions or appointments. Interactions are meetings such as a meal/snack, a drop-in visit, a flexible event, an additional recurring event, and the like. Interactions have a set number of openings that are each acceptable by one associated rep. Appointments are meals/snacks, presentations, seminars, conferences, meetings, and the like. Appointments are acceptable only by the specific associated rep selected by the sales target. The sales target uses the search component for operations such as to determine information related to one or more associated rep, transmit one or more e-mail message to one or more associated rep, and the like. The sales target optionally uses the system to disassociate from any associated rep. The sales target optionally exports data to an external device and is interconnected to a digital media receiver receiving one or more operating system control file for receiver and one or more media file from a media transmitting component of the server. The media file comprises data such as the daily schedule of offered and or accepted interactions and or appointments for that sales target, rep information for associated rep(s) that accepted the interactions and or appointments, advertising information, information about upcoming events, education information, information of personal interest (such as sports information, arts information, financial information, travel information, cooking information digital photographs, etc.), and the like.

One or more rep is connected to the network and optionally connected to one or more related rep through the network or through a second network. The rep accesses the server through the security component, which compares security information supplied by the rep to rep information contained in a rep file stored in the server database. The rep inputs rep information comprising one or more digital photograph of the rep, one or more digital product logo, offered items, general information, specific information, and the like. Specific information comprises educational material, promotional material, marketing material, one or more link to external information, and the like. Rep information is updateable and stored in the rep file. The rep uses the search component designating a name, geographic data, demographic data, and the like to build a search to discover one or more sales target connected to the network. The rep uses the results of the search to create an association with one or more sales target and maintains a list of associated sales target(s). Alternatively, the rep associates with one or more sales target without using the search feature. The rep optionally uses the list to access and view archived information for one or more listed associated sales target, post targeted information on the rep's web page for a selected listed associated sales target, and use an e-mail component to email one or more associated sales target. The archived information is sales and service interaction history with the listed associated sales target. The rep uses the scheduler to view one or more interaction and or one or more appointment offered by one or more associated sales target. The rep electronically accepts one or more interaction and or one or more appointment offered by one or more associated sales target. When the rep accepts an interaction and or appointment, the system electronically links rep information to the event. The rep uses the scheduler to view the status of the interaction(s) and or appointment(s) accepted by the rep. In an embodiment, the rep uses the scheduler to electronically compare one or more interaction and or appointment offered by one or more associated sales target with his/her schedule and uses the comparison to accept one or more offered interaction and or appointment. The rep optionally cancels one or more accepted interaction and or modifies one or more accepted appointment and adds and or modifies a rep annotation for an accepted event. The rep uses an email component to respond to one or more e-mail message sent by an associated sale target using the system. The rep optionally disassociates from any associated sales target. The system logs and archives offered and or accepted interaction and or appointment activity and optionally sorts and reports the logged information.

When a sales target modifies, updates, cancels and or confirms an appointment with an associated rep, the rep is optionally alerted to the change via an alert, such as a signal and or a message sent to a device, such as but not limited to, a landline phone, cellular phone, pager, PDA and the like.

The system administrator may optionally extend the time period that one or more rep may view and accept openings for interaction(s) posted by one or more associated sales target without violating any scheduling horizon limit established by any sales target. When a rep is designated as one having access to an extended time period to accept openings for interaction posted by associated sales target(s), the system provides an option for the rep to set up an automated acceptance that repeats the rep's acceptances from a prior time period in a future time period; the system is set to notify the rep whenever it is unable to make an automated repeat acceptance.

The server optionally interacts with the scheduler to a) request a confirmation from the rep that accepted one or more sales target posted meal/snack appointment a predetermined interval, such as from one to seven days, prior to the date of the appointment and b) notify the sales target when the rep responds to the confirmation. The notification includes an e-mail message, a change in an icon associated with the appointment, and the like.

The rep optionally requests an upgrade from a network system administrator. The upgrade prompts the server, which interacts with the scheduler to extend the set period of time for the rep to respond to one or more opening posted by one or more associated sales target. The scheduler automatically accepts one or more opening of one or more associated sales target for the upgraded rep when the upgraded rep selects a repeat option over a predetermined span of time. The server notifies the upgraded rep when an automated repeat acceptance for the upgraded rep is not available.

The server tags one or more sales target when one or more sales target inputs a code. The server uses the code to display a web page of the upgraded rep to the tagged sales target. The web page is displayed to the tagged sales target at any time during access to the network. The server optionally displays one or more web page to the tagged sales target where more that one upgraded rep tags the sales target. The server blocks access to the tagged sales target information by reps other than upgraded reps tagging the sales target for a designated period of time. The server notifies one or more upgraded rep when one or more sales target first accesses the network when the sales target inputs an address in the sales target information that is located in the rep's territory. The server looks up the address in a file of territories and compares the address to the territory inputted in the upgraded rep information.

The system is optionally used as a search engine to discover other users in the network.

### BRIEF DESCRIPTION OF THE DRAWINGS

FIG. 1 is a schematic diagram of the overall system;

FIG. 2 is the first of three sheets depicting a flow chart of the method of the system;

FIG. 3 is the second of three sheets depicting a flow chart of the method of the system;

FIG. 4 is the third of three sheets depicting a flow chart of the method of the system;

FIG. 5 is a flow chart of a process to initiate an embodiment of the system;

FIG. 6 is a flow chart of a set-up process of an embodiment of the system;

FIG. 7 is a flow chart of set-up processes in an embodiment of the system;

FIG. 8 is a flow chart of an administrative module of an embodiment of the system;

FIG. 9 is a depiction of levels of interactions of users in an embodiment of the system;

FIG. 10 is a flow chart of interactions between a sales target and a rep in an embodiment of the system;

FIG. 11 is a depiction of a search engine component of the invention used to locate new products in an embodiment of the system;

FIG. 12 is a flow chart of the steps used to search for product information using an embodiment of the system;

FIG. 13 is a flow chart of the steps used to search for educational resources using an embodiment of the system;

FIG. 14 is a flow chart of the steps used to search for patient related information using an embodiment of the system; and,

FIG. 15 is a diagram of the options available at a rep service page in an embodiment of the system.

### DETAILED DESCRIPTION OF THE INVENTION

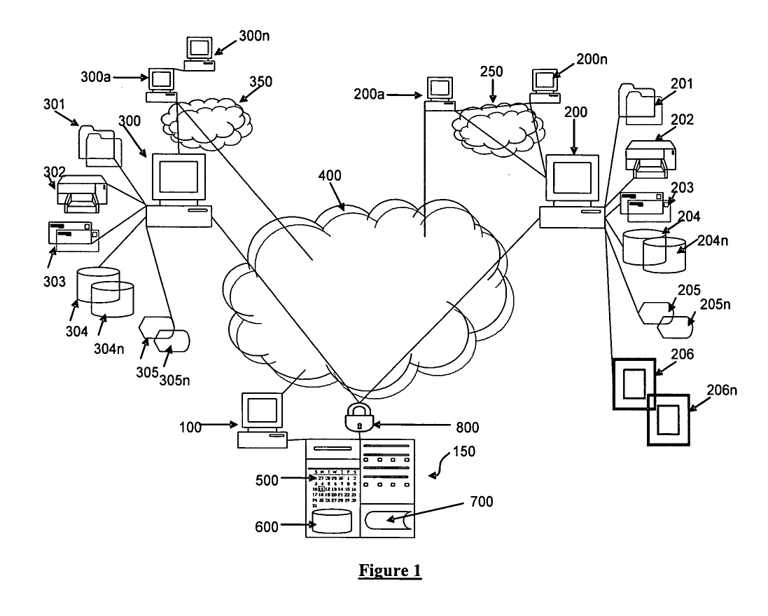

As depicted in FIG. 1, the system comprises a system administrator 100 and one or more user 200, 300. The user optionally comprises any given sets and or subsets of users. In an embodiment, a first user is a sales target 200 interested in and or using products/services and a second user is a rep 300 marketing products/services to the sales target 200. One skilled in the art would understand that users could be any single user or group of users. The administrator 100, one or more sales target 200, and one or more rep 300 are connected in a network 400, such as the Internet. Services provided in the system are located on a server 150 with computing capabilities connected to the network 400. The server 150 is controlled by the administrator 100. Services comprise 1) a scheduler 500; 2) interaction with a server 150 database 600 and a digital media server 700 capable of compiling digital image and or audio files from the scheduler 500 and or other data; 3) updating and uploading multiple image and or audio files; 4) creating and managing image and audio file queues and transmitting one or more digitized image and or audio file to one or more sales target 200. Database 600 stores files comprising 1) user profiles and demographic information; 2) calendar information; 3) events; 4) specific information related to the events; 5) general information; 6) links, and the like. Specific information related to events comprises details offered by a user to one or more second user who can respond to and provide information associated with the events to maintain the events. General information comprises descriptions, postings and the like.

The system administrator 100 administers the services available to the one or more sales target and one or more rep through the system server 150, the scheduler 500, the server database 600, and the digital media server 700. Each sales target 200 and rep 300 accesses the server 150 using a security device 800, such as a username and password. Each sales target 200 is optionally connected to one or more related sales target 200a, 200n through the same network 400 or through a separate network 250, such as an intranet, a private network, and the like. The sales target 200 comprises means to archive 201, print 202, e-mail using the system 203, interact with one or more sales target database 204, 204n, and import data from or export data to one or more wired or wireless external device 205, 205n. The sales target 200 optionally comprises one or more digital media receiver 206, 206n interconnected to the server 150. The media receiver 206, 206n receives information from the digital media server 700.

Each rep 300 comprises means to archive 301, print 302, e-mail using the system 303, interact with one or more rep database 304, 304n, and import data from or export data to one or more wired or wireless external device 305, 305n. Each rep 300 is optionally connected to one or more related rep 300a, 300n through the same network 400 or through a separate network 350, such as an intranet, private network, and the like. As shown in FIG. 1, a rep 300 is optionally interconnected in one or more permission-based hierarchy in which one or more rep 300a in an upper level of the hierarchy is able to control, support and otherwise manage use of the system by one or more rep 300n in a lower level of the hierarchy.

The system is implemented in a networked computing environment. The computing environment includes user computers 200, 300 and at least one server 150. The computers may be any of a variety of computers that include a central processing unit, memory, storage devices, display devices, and various other devices. The computing systems are connected through a network 400 through which the computers exchange information. The network 400 is wired or wireless, private or public, extended or restricted, and the like, and may be connected to one or more device for retrieving information stored on portable wireless media such as smart cards, implantable micro-processing chips, and the like, and may be further connected to other separate networks. Other variations are also possible, such as but not limited to the system implemented on a non-networked computer or display device. In an embodiment, the present system of the invention is a web-based tool implemented on the Internet. Users 200, 300 access the server 150 using any means and from any location connected to the worldwide web.

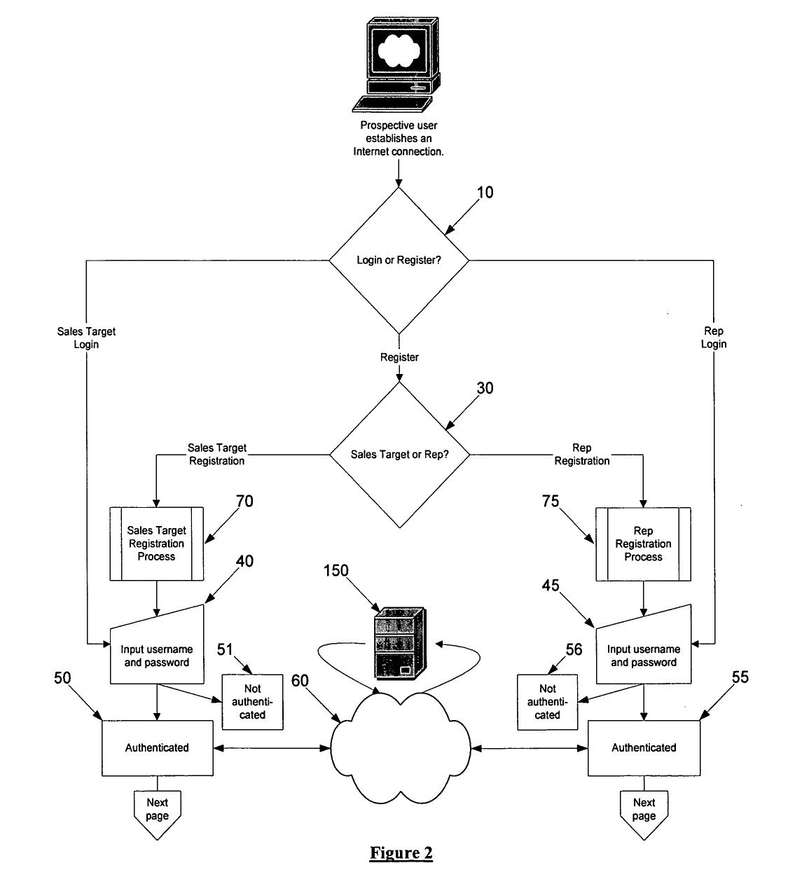

As depicted in the flow diagrams of FIG. 2 through FIG. 4, a user 200, 300 accesses the system. As a first step 10, the system prompts the prospective user to login as a sales target or as a rep, or to register to use the system. To login, a registered user must input a valid username and password 40, 45. The system performs a look-up of the user's username and password in the database 600. When authenticated 50, 55, a user is connected 60 to the system and to the server 150 as either a “sales target” user type or as a “rep” user type. The system determines user type from the registration information associated with an authenticated username. Where the system is unable to authenticate a user, the user is prompted to retry the login, request that a forgotten password be e-mailed to the user, and or contact 51, 56 the system administrator.

A prospective “sales target” user not previously registered is prompted to input information to register with the system 70. A prospective “rep” user not previously registered is prompted to input information to register with the system 75. Whether a prospective user registers as a “sales target” or as a “rep” is dependent upon self-classification/selection. Registration includes inputting demographic and related personal information, and the like.

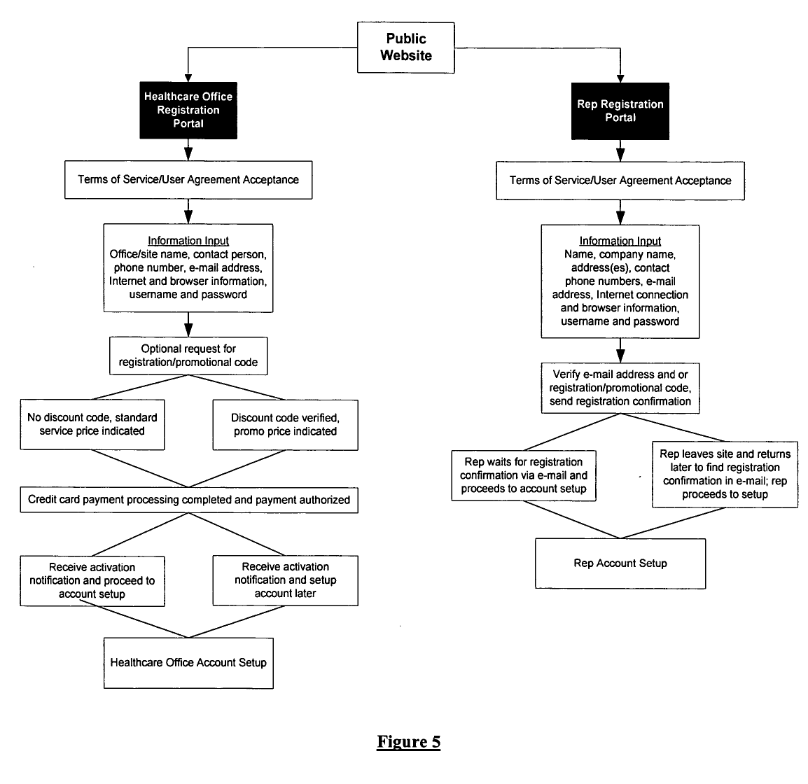

FIG. 5 is a diagrammatic flow chart depicting the registration process of an embodiment of the system. FIG. 5 depicts a healthcare office as the sales target for example purposes; however, one skilled in the art would readily understand that the steps depicted in FIG. 5 would apply to any type of sales target—rep relationship. Examples of sales targets include any type of office, clinic, hospital department, manufacturer, retailer, etc. The sales target accesses the system through a specified contact, such as an administrator, staff, and the like. Optionally, a sales target user designates an administrator with authority to change the settings recorded during account setup. The administrator user inputs information of individual users related to the sales target. The administrator optionally creates separate sub-account usernames and passwords for individual users related to the sales target. The system correlates sub-account usernames and related data in the database 600. The system allows an individual sales target user to change his/her password at will, but only a sales target administrator may create, change or delete a sub-account of a sales target account and or a username for a sub-account.

A sales target inputs information such as the area of industry, specialty, etc., descriptions about the sales target, and the like. In an embodiment, descriptions include but are not limited to, affiliations to other sales targets. In a preferred embodiment, the sales target is a healthcare office and descriptions comprise affiliations to other practices and or healthcare providers, such as hospitals, clinics, practices and the like, insurance carrier affiliations, etc.

In an embodiment, a prospective user accesses the system through a web portal designated for a specific user type. An initialization screen displaying a welcome message and an approximate length of time to complete the registration process is optionally displayed. Terms of service and a user agreement are located or linked to the initialization screen. The prospective user indicates acceptance of the terms of service and the user agreement to continue registration. If the user does not indicate acceptance within a given number of times that the prospective user accesses the site, an error message is displayed.

In an embodiment, a user type-specific screen is presented to the user comprising preset fields for the user to input information, including but not limited to demographic information and a username and password. The username and password are security means used for future access and use of the system. Usernames are coupled to the individual user and or the association of the user to a group, such as a professional group practice, clinic, hospital, company, business unit, sales division, etc. The couplings are optionally maintained and used for controlling and or tracking individual and or group use within the system, such as access, use of specific functions, activities, billing purposes, and the like.

The system optionally provides means for the user to input a code, such as a promotional code. The code is used to track activity and optionally used for recruiting users during the course of business. The request for a code repeats for a set number of times until the code is recognized by the system. Users without a code or with a code not recognized by the system are allowed access to the services of the system; however, where no promotional code is input by the user, the user is optionally billed for using the services of the system in accordance with applicable terms.

A code is optionally used by a user for full, partial or discount payment of any fee. When a user inputs a code, a processor performs a look-up for the fee associated with that code and the fee is displayed to the user. If no code is inputted, a default fee is optionally displayed. Where a fee is due, the user is prompted to input credit card information including but not limited to: card type, card number, cardholder's name, expiration date, and security code found on the credit card. The inputted credit card information is verified and processed for payment in an amount equal to the fee displayed to the user. The system provides email confirmation of any payment to the user upon successful completion of transaction authorization. The user is then displayed a screen for account setup. The user may continue or login at another time using his/her username and password to input information to setup the user's account on the system.

Sales target users are provided individual usernames and passwords. Where a user is a company, each representative associated with the company is provided an individual “rep” account, company-affiliated username, and password. The company and its representatives use a username and password to login, complete account setup, and use the system. Each representative appended to a company rep account is assigned a username and password in a company registration/setup process. Reps not provided username and password by their companies are associated with their companies ad hoc via 1) a match with the corporate domain name required for rep registration, 2) by the rep selecting the company name from a list during setup, or 3) by the rep inputting the company name during setup.

Alternatively, a “courtesy” account (i.e., an account with a no-fee service agreement) may be issued to a user. A username and password are created by a prospective user during “courtesy” registration. Courtesy accounts may be set up and or otherwise configured by the system administrator to limit “courtesy” account user access to specific services and or to restrict the user to specific service modules and or portions of the services.

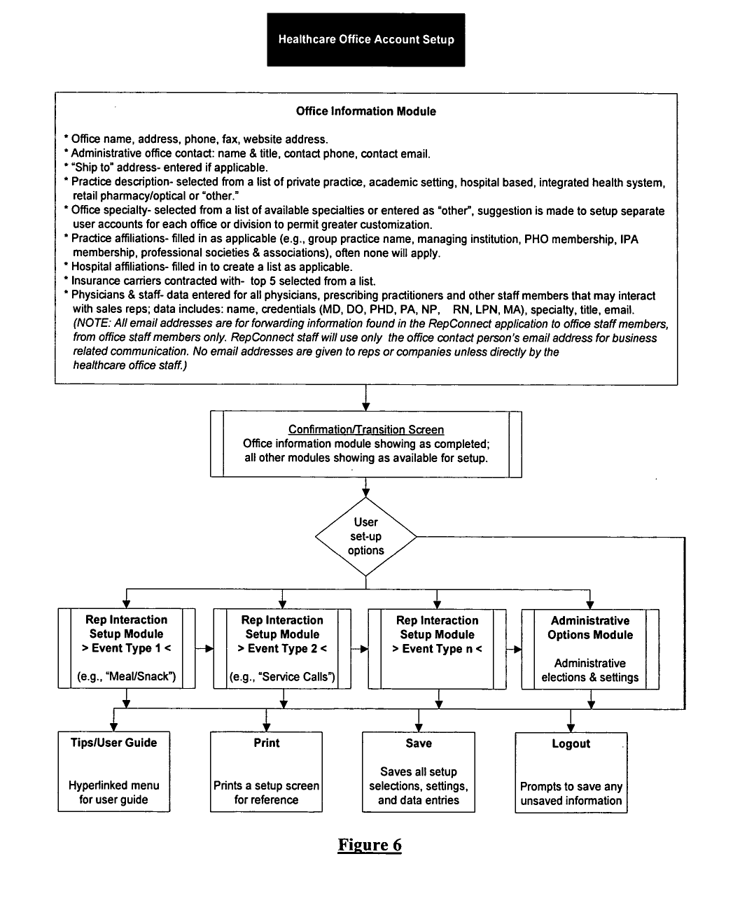

In an embodiment depicted in FIG. 6, each user of a healthcare office sales target inputs demographic information, such as but not limited to name, company name, address, phone numbers, email and individualized username and password for his/her account. Where the user is a sales target, a referral code is optionally provided upon registration.

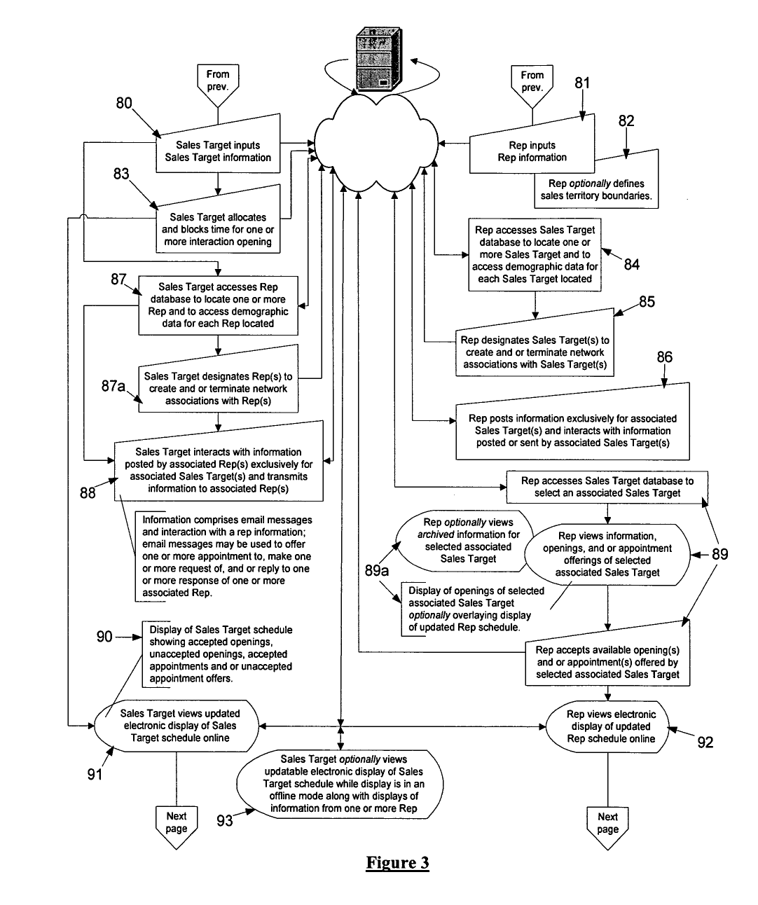

Returning to FIG. 3, a sales target makes functional and administrative setting selections and inputs other information 80 using the system and a rep makes functional and administrative setting selections and inputs other information 81 using the system. Database 600 stores the information in files specific to the user. Information includes but is not limited to: Name/Demographics, Sales Target name, Sales Target Location (state, city, zip), Sales Target Qualifier(s) (e.g., medical specialty), Sales Target Groups/Associations, Sales Target Affiliation(s) (e.g., insurance, hospital), Professional Practice Type, Contract Type, Contract Status, Registration Date (date range), Renewal Date (date range), Rep First Name & Last Name, Rep Location (state, city, zip), Rep Company Name, Rep Product/Service Name(s), Contract Type, Contract Status, Rep Registration Date, (date range), Renewal Date (date range), and the like. A rep optionally inputs information that defines his/her sales territory 82.

To illustrate the registration component of the invention, the following example is provided.

### EXAMPLE I

In an embodiment wherein a healthcare office is a sales target for one or more rep associated with one or more pharmaceutical company, a list displayed to a user during registration comprises “healthcare provider” or other indicator for a healthcare office, and “sales representative.” Where the user selects “healthcare provider,” the registration screen fields include, but are not limited to: Office name, Contact person, Phone number, Email address (duplicated for validation), Username for application, and Password (created by user and duplicated for validation). Users are authenticated by providing a valid email address. A rep is authenticated by providing a valid email address including his/her company's domain name. If the rep cannot provide a company domain name, the rep provides a sales target referral code.

In this example, “sales representative” is a rep associated with a pharmaceutical company. One skilled in the art would understand that any user marketing to the healthcare provider may be substituted for a pharmaceutical company. The pharmaceutical company and one or more associated rep is registered, through any mechanism, such as execution of a service agreement, to access the system prior to interaction with the services.

After a user inputs information for registration, the system optionally performs a look-up of the information inputted to verify the user. Upon completion of registration, the system sends an activation notification/registration confirmation for the new account to the user's email address. The notification/confirmation includes information including a hyperlink to prompt the user to return to the website to complete the setup and activate the account. The system associates users by a reference and initiates further input screens based on the reference. The system automatically allows access to services based on the reference. As an example, the reference may denote a courtesy account and the system limits the user to a given portion of the website.

The system provides means for input of information for account set up with approximations on completion time described for the user. In an embodiment, information input is divided by “tabs” with hyperlinks on a web page that a user clicks to access different screen displays. In an embodiment, data inputted comprises information about the user, scheduling and or other types of parameters, preferences, and administrative options.

Information about the user comprises demographic information, such as but not limited to office name, address, land phone, fax, mobile phone and website. Where the user is a sales target, the information inputted includes a contact name for an administrator provided access to the system. Where the user is a rep, the information inputted may or may not include a contact name for an administrator provided access to the system. The contact may or may not be the same as the contact for other users to contact directly. Additional information for the contact, such as title, phone number and email is inputted by the sales target or by a rep administrator as applicable. Where the user is a sales target, a separate address for shipment of requested items is optionally inputted if such address is different from the office location address.

Means is provided for a sales target to provide specific information. In an embodiment, a website provides input fields for listing of personnel who interact with other users of the system. Information collected regarding healthcare office personnel includes name, credentials, medical specialty, title, email and the like. The listing comprises designations such as office personnel assigned to one or more group. The list and the information inputted are updateable at any time by the sales target. Lists are used in messaging, scheduling and the like. Lists are used by A) sales targets to 1) forward schedules and specific information generated by the system, and 2) to optionally populate sales target attendance for a scheduled appointment or interaction; and, B) reps (and their companies) to learn more about the sales target. Forwarding of information is not limited to forwarding by means of the staff list. The user optionally forwards information to e-mail addresses not on a staff list. Personnel are any user that would interact with a sales representative, such as, in an embodiment, physicians, prescribing staff and other staff.

The following example illustrates information provided where the sales target is a healthcare office.

### EXAMPLE II

During account set up, a user in a healthcare office inputs information at the system's website to designate a practice type. Practice type may be selected from private practice, academic setting, hospital-based integrated health system, retail pharmacy/optical or other. The practice type designation provides information to reps accessing the system to determine healthcare offices that are sales targets of interest to that rep. The user optionally designates one or more specialty, which may be selected from a pre-populated list that includes the option to list “other.” The input site for the information includes a field for practice affiliations. Affiliations include designations such as a practice management company, IPA, PHO affiliation(s), managing institutions, and the like. Collection of practice affiliation information enables the system to track selected groups to provide discounts, marketing and other needs as well as to provide the affiliation information to associated reps. A field for input of hospital affiliations is provided. Hospital affiliations include local, networked, and the like. The user optionally designates contract formularies. Contract formulary designations are used by other users to offer services to the office.

The rep information component of the system will now be described. The system comprises means for a rep to access and interact with the system. The rep creates a rep file located in the database 600 of the system. The rep file comprises information about the rep, such as but not limited to rep name, company, address, phone(s), product lists, related resources, and the like. In an embodiment, related resources are those used by a physician in providing patient care. The system allows a sales target to view the information in the rep file.

A rep determines products/services included in that rep's file. A predetermined list is optionally used to designate a search category for the product/service. Reps designate at least one such category for each product, but may designate more than one category for a product/service. The system allows the rep to update listed products/services and or categorizations of the same at any time.

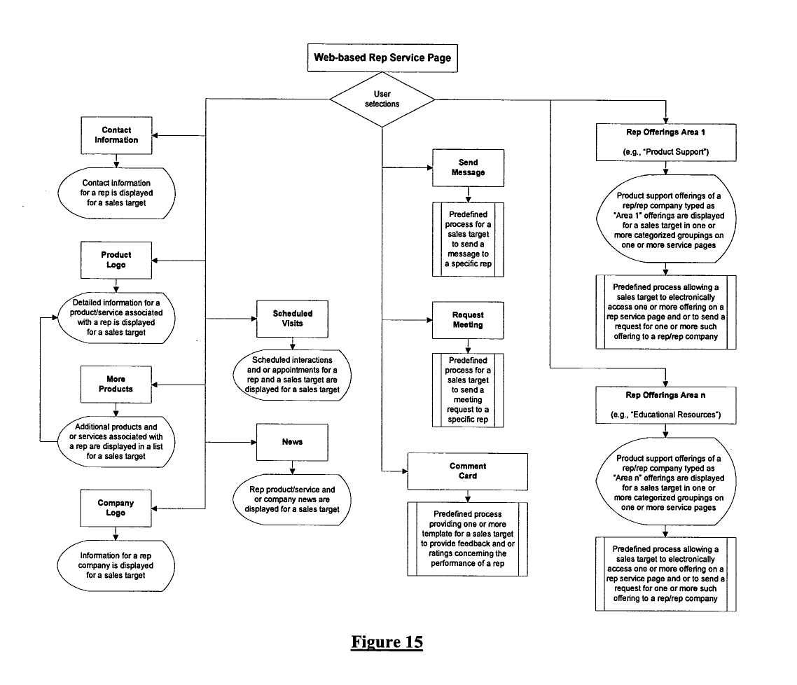

As depicted in FIG. 15, the system comprises one or more web-based rep service pages located at a website. One or more rep and or rep company inputs information to populate the service pages with information, which is viewable by sales targets. A sales target optionally uses the system's search engine in conjunction with predetermined search category designators to locate specific information or browses through the rep pages. In an embodiment, the rep pages comprise rep information regarding the rep, new and or targeted products, and optionally, product promotion and support, education resources, news and alerts, and the like. In an embodiment, the information is useful to the sales target. In a preferred embodiment, the information is related to patient care. Information related to patient care optionally comprises prevention, diagnosis, treatment, research, education, finance, and the like. Information is optionally cross-linked to products and or services.

The rep pages comprise means for the rep to provide information and optionally materials to a sales target, and optionally for the rep and or rep company to track sales target interaction with such information and materials. A rep optionally adds hyperlinks on his/her rep page that link to information located outside of the system. As an example, a rep adds a logo for a product on his rep service page. The logo is a hyperlink that, when activated, produces a webpage with information regarding the product. In an embodiment, the logo represents a drug and the hyperlink produces a webpage with full prescribing information for the product or an approved brief summary of prescribing information. As a further example, a rep adds a logo for the rep's company to the rep's service page. The logo represents the rep's company and is a hyperlink to the company's website containing information about the company. One skilled in the art would recognize that a hyperlink could be linked to a variety of information, including but not limited to educational, news, advertising and marketing, personal, etc.

A rep's service page comprises means for a sales target to send a message to the rep. The means may be an address for traditional mailing, an e-mail hyperlink, a website IP address, and the like. A rep uses the system to view a list of messages and or individual messages received from one or more sales target and to reply to these messages. The rep cannot use the system to initiate an electronic message to a sales target. Optionally, a rep affiliated with one or more selected company uses the system to initiate an electronic message to any sales target that allows such optional functionality for a limited number of designated reps.

In an embodiment, rep information comprises information generated by a rep and optionally by a rep company and or one or more third party. Information from a third party is information such as news or press releases, journal articles, and or other materials concerning the product(s) sold by the rep. In a preferred embodiment, the information from third parties comprises information about new products, such as indications and or labeling changes for a drug. Such information may optionally be flagged as “new” for various periods of time in order to call the information to the attention of sales targets.

Optionally, a rep and or rep company differentially populates interactive, web-based rep service pages for different specialties, such as, in an embodiment, different medical specialties and or individual physician interests, by providing information, such as but not limited to a hyperlink or related link to a document or to a website in conjunction with one or more profiling designator, such as a medical specialty designator. Links may be associated with one or more product/service provided by the rep. In a preferred embodiment, the product is a new or targeted product, such as but not limited to a new drug or device, an update on a product, other product and or educational information relevant to a physician practicing in one or more designated specialty, and the like.

Returning to FIG. 1, the system comprises an interactive calendar module 500 and creatable, updatable, and accessible files contained in one or more database, 204, 204n, 304, 304n, 600 containing information about users. In an embodiment, the present invention operates in a networked environment 400 such as the Internet. A website is provided for user access and interaction. A server 150 interacts with user computers 200, 300 through input and output transmission to and from each other using network mechanisms, such as storing and using “cookie” files, caches, encryption, session management, and the like.

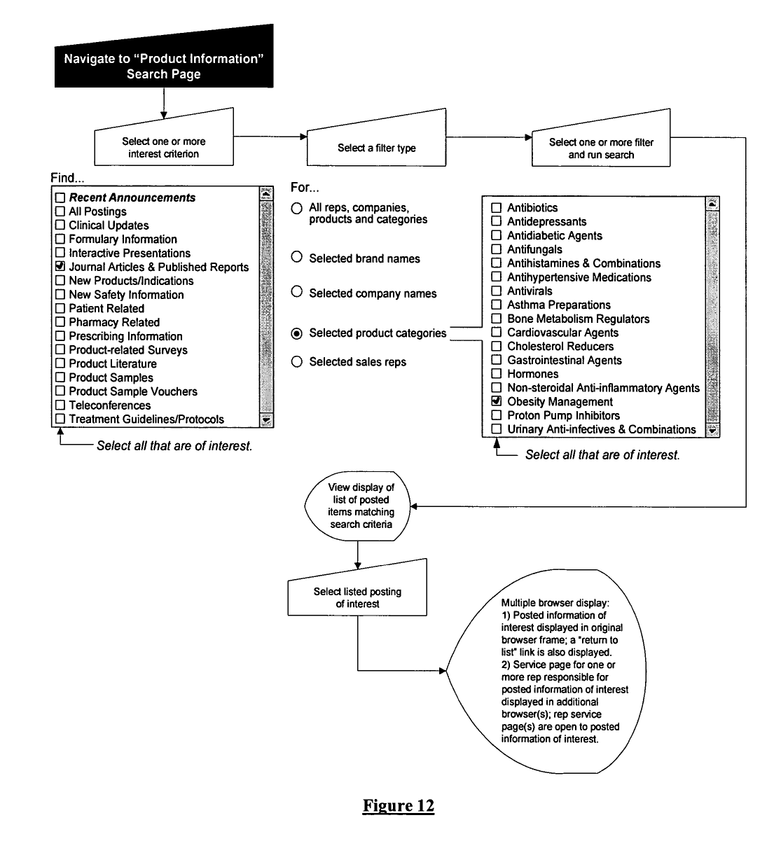

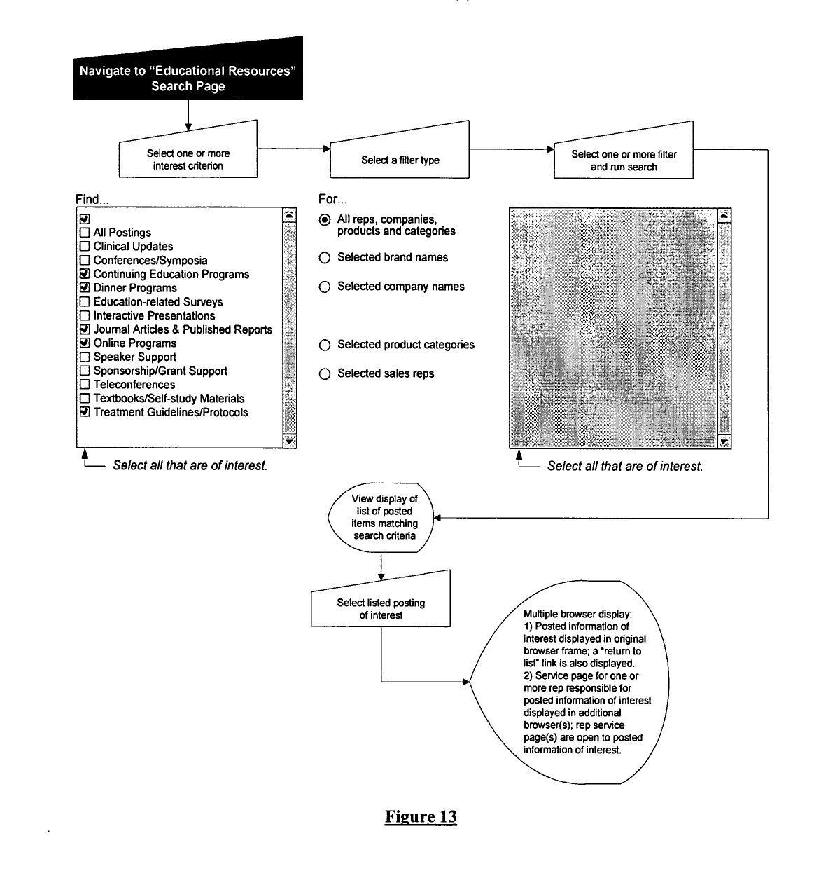

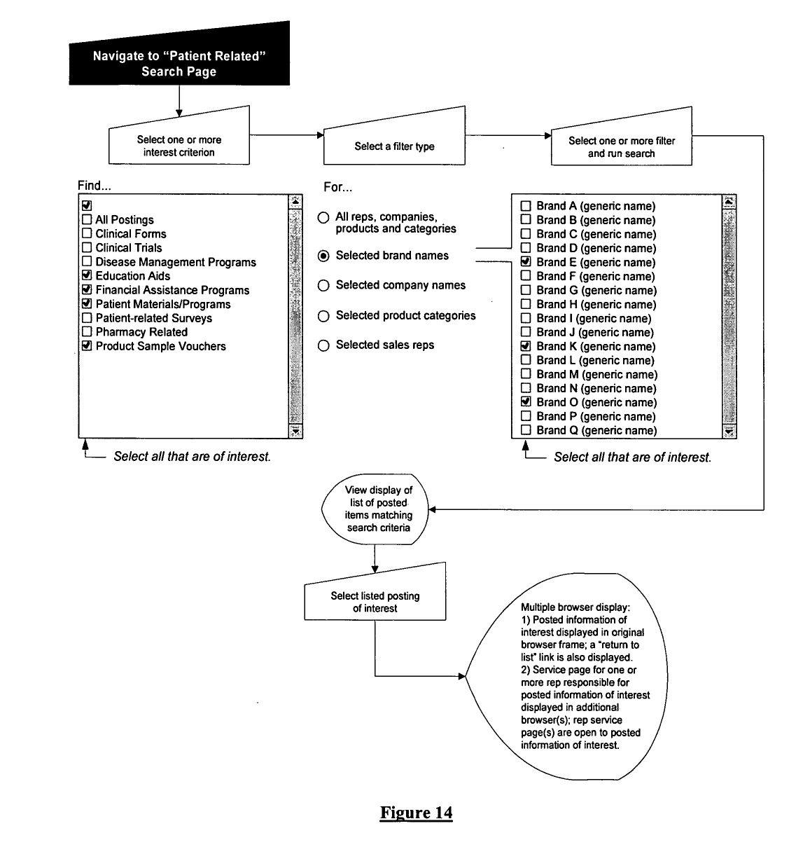

As depicted in FIG. 6 through FIG. 14, the system comprises applications and modules that provide interaction between one or more database or file and the site. One or more application populates, retrieves, modifies and stores data and connects with other data sources linked to a posted or scheduled event or to information associated with an event and makes other data available to one or more selected user of the system.

Returning again to FIG. 3 the rep accesses 84 sales target information in the database 600 to locate one or more sales target and to access demographic data for each sales target located. The rep designates 85 one or more sales target to be added to a list of sales target(s) that the rep desires to visit and or that the rep wishes to market products/services to via the system. The designated one or more sales target is saved in an updateable file in the database 600. In an embodiment, the rep uses the system's search engine to determine one or more sales target to be included in a list of designated sales target(s). The list, called, in an embodiment, a ClickList,™ is a list of the sales target(s) from which the rep desires to 1) accept available openings for scheduled interaction, 2) receive and respond to messages including appointment invitations, requests for services or resources, and the like, and 3) to provide any type of information including but not limited to information about the rep, the rep's company, products and or services, resources support, educational material, and the like. The rep adds specific sales targets to his/her list so that each selected sales target will have a nexus with the rep and the rep's/rep's company information via the system. A sales target likewise designates reps to a list. Designation of a sales target by a rep automatically adds the rep to the sales target's list.

The system allows any rep or sales target to unilaterally create a network association with any sales target or with any rep simply by the rep locating a specific sales target or a sales target locating a specific rep and designating the respective sales target and rep as included on the sales target's or rep's list. The system allows a user to unilaterally terminate a network association with any designated sales target/rep by deleting the designated sales target/rep from the user's list. By deleting a rep, that rep's list no longer lists the sales target that deleted the rep; by deleting a sales target, that sales target's list no longer lists the rep that deleted the sales target. A rep or a sales target may revise his/her list at any time. When a specific sales target and or a specific rep has designated the other to that user's list that sales target's available calendared interactions are accessible by that rep. The list feature of the invention provides an association in the system between a rep and a sales target such that the information added to the system by one associated user is viewable by the other associated user, and vice versa.

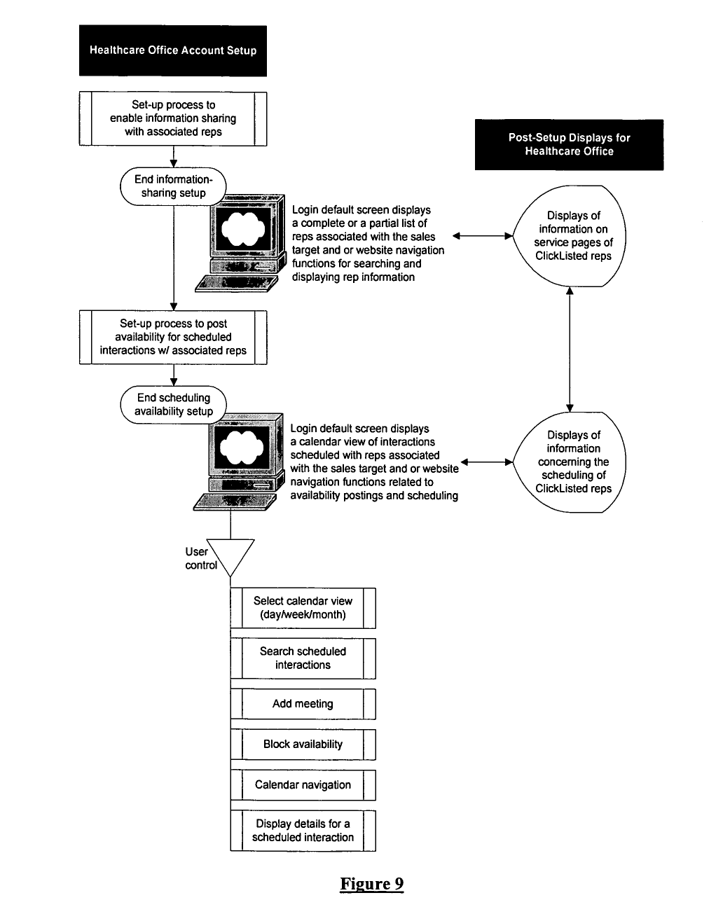

In an embodiment depicted in FIG. 9, interactions of users comprise information sharing, which at the option of a sales target may further comprise sales target postings of availability for scheduled interactions with associated reps (i.e., listed reps) and rep interaction with these postings. Returning to FIG. 3, the system provides means for a rep to post 86 information exclusively for associated sales targets (i.e., listed sales targets) and to interact with information posted or sent by associated sales target(s). The system provides means for a sales target to interact 88 with information posted by associated rep(s) exclusively for associated sales target(s) and to transmit information to associated rep(s) regardless of whether a sales target opts to post availability for scheduled interactions with associated reps.

The system allows a rep to (a) transmit information to associated sales target(s) by means of posting information to that rep service page(s), such service page(s) being accessible and viewable by associated sales target(s); and (b) receive and reply to e-mail from associated sales target(s). The system allows a sales target to (a) interact with information found on an associated rep's service page(s); and (b) send e-mail messages to associated rep(s) in a manner that prevents disclosure of sales target's e-mail address to associated rep(s). The type, scope, format and or amount of information that a rep can post to his/her rep service page(s) is limited by the system administrator 100 in accordance with the type and level of system service that is to be available to that rep, and may optionally be further limited by one or more related rep 300a, 300n. The process for a sales target to allocate and post availability for scheduled interactions with associated reps is further described below.

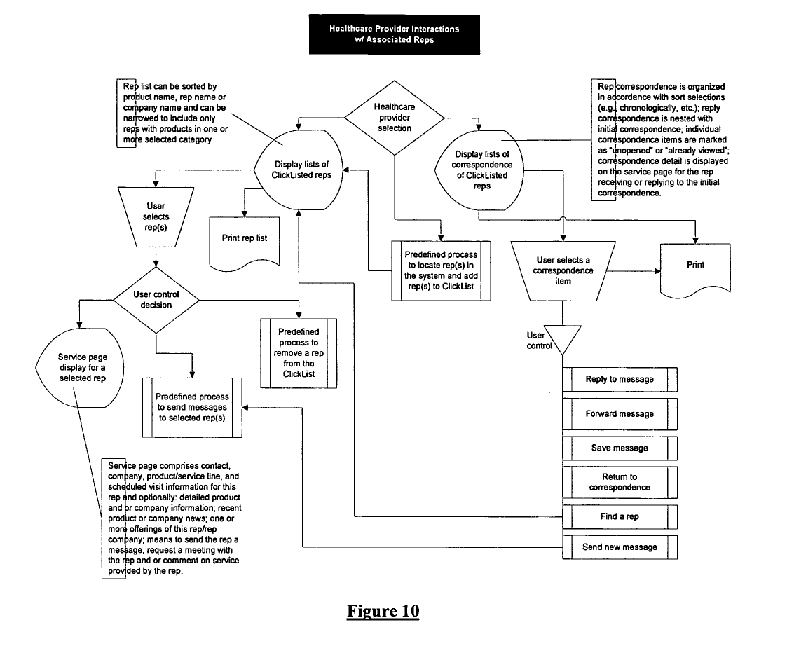

As shown in an embodiment depicted in FIG. 10, users interact with each other in the system. After a rep creates an association with a sales target or the sales target creates an association with a rep, that rep and that sales target are uniquely linked in the system. The sales target uses the linked rep information to schedule appointments, learn about new products, request information and resource support, and the like. The rep interacts with associated sales target(s) by accepting openings for scheduled interaction, accepting appointment invitations, responding to messages, supplying information, determining the preferences of the sales target and the like. Building on these links and interactions, a rep company optionally arranges for reps related to that company to access additional modules and applications and or upgraded functionality so as to enable 1) the rep to: (a) define his/her sales territory by state, city, metropolitan statistical area and or zip code; (b) include the rep's names together with company and product affiliation(s) in a generalized rep database located on the system that is accessible by any sales target regardless of whether there is an association between the rep and the sales target;

(c) extend the time period to view and accept openings posted by associated sales target(s) indicating availability for various kinds of scheduled rep interaction without violating the scheduling horizon limits of any such sales target(s); (d) receive automatic notification of openings for one or more interaction arising with an associated sales target due to cancellations of scheduled interactions; (e) access system-wide scheduling data and related rep data; (f) overlay a display of his/her schedule with openings for an associated sales target and to superimpose a display of interactions that related reps (e.g., sales teammates) have scheduled with that sales target; (g) personalize and differentially enhance his/her rep service page(s) for each associated sales target with the variable posting of any or all of one or more brief message, promotional slogan, rep photo, product logo, company logo and or other digital image file, MP3 and or other digital audio file, and or other electronic file, and or a hyperlink to a web page and or to a digital image, MP3 or other electronic file, and the like; (h) provide electronic interaction with an enhanced rep service page by associated sales targets that have posted one or more offering to that rep, the electronic interaction includes various posted items and hyperlinks that an associated sales target can interact with; (i) place advertising in print and electronic displays of rep and rep schedule information viewed by sales targets irrespective of rep associations; (j) preferentially list information in displays of search results for sales target searches that comprise information posted on rep service pages; and (k) gain access to individual sales target details, including but not limited to histories of associated sales target searches and interaction with rep service pages, names of personnel employed or associated with an associated sales target, such as, in a preferred embodiment, physician lists, and more complete demographic information; and 2) the company to (a) activate controls to permission, tag, and otherwise govern and manage rep postings to rep service pages using a hierarchical method and or other methods; and (b) link advertising with service pages for company reps electronically and or by reference.

In an embodiment, a rep uses the enhanced service page to create individual sales target files to track interactions, requests, traffic on the service page, e-mails, phone calls, comments on service, and the like pertaining to an associated sales target and to respond to the requests and interests of an associated sales target. With an enhanced service page, a rep offers and schedules events, resources and information, such as but not limited to, educational programs, online distance learning curricula, teleconferences, product samples, coupons, treatment guidelines/protocols, and or information specific to one or more products or services.

The calendaring mechanism will now be further described. Referring to FIG. 3, a sales target 200 accesses the system and defines scheduling availability and applicable scheduling limitations 83 by making selections and by entering text into specified fields. The system provides means for a sales target to specify preferences for interactions conducted between the sales target and associated rep. The sales target sets calendaring data specific for interactions, such as the frequency and availability of the sales target for interactions with reps. Frequency includes any time period, such as weekly, bi-weekly, monthly, quarterly and the like. A sales target may restrict the number of times an individual rep and or reps of an individual company may interact with the sales target during a time period. The sales target designates other preferences, such as a number of minutes that a rep may have for the interaction, the number of minutes of preparatory time allotted, and the like. The user optionally designates restaurants and other guidelines regarding meal/snack meetings, such as time, dietary needs, preferences and the like. An embodiment of the invention comprises links to websites sponsored by restaurants and catering companies.

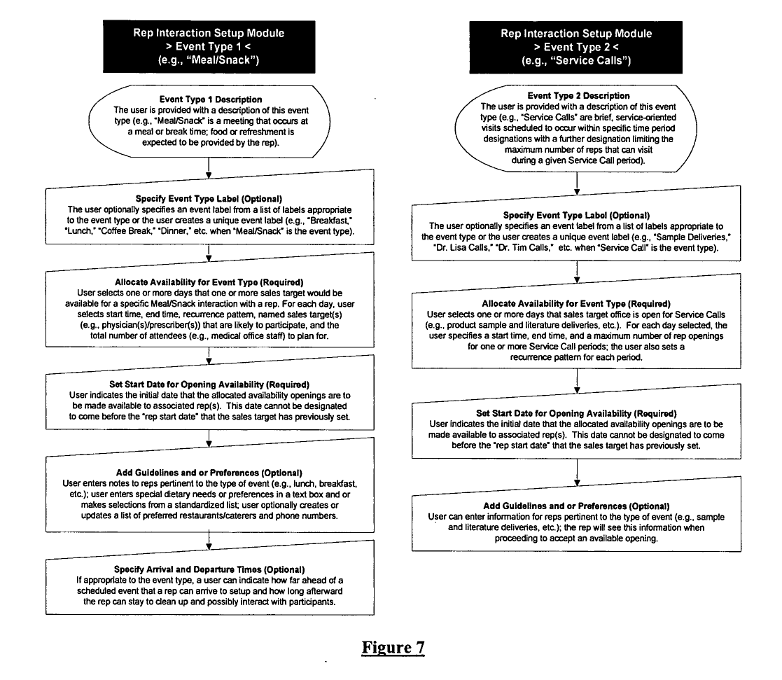

As shown in an embodiment depicted in FIG. 7, the calendaring mechanism is used to allocate sales target availability for scheduled interactions with associated reps, create, edit, schedule, and cancel interactions and requested meetings with one or more rep and view any scheduled interaction/appointment and or period of the schedule. Types of interactions available through the calendaring mechanism include but are not limited to meal/snack meetings, recurring service calls, requested meetings, and the like. “Meal/snack” is used for convenience herein and should not be construed as limited to any time period. As an example, a meal/snack meeting designated for early morning would have a breakfast or similar menu provided.

Posting of interactions and appointments is limited to sales target users. In an embodiment, one or more sales target offers/requests any type of interaction with one or more associated rep, such as but not limited to a breakfast, lunch, coffee break, a service call, or an individual appointment meeting with one or more sales target personnel, such as a decision maker and or staff member. Reps associated with a sales target use the system to schedule meal/snack meetings and service calls with the sales target in accordance with available allocated openings at the times preferred by the sales target.

Using the system, a sales target user creates a request for any type of interaction with one or more specified associated rep. The system indicates the request as “pending” on the scheduler until accepted by the rep, at which point the system designates the request as “scheduled.” Notice is transmitted to the specified rep upon a sales target creating a request. The rep replies to the request by rejecting or accepting the requested interaction. When accepting or rejecting the interaction via the system, the rep can add a message for the sales target. A rep can reply to an interaction request with a message once per request. In an embodiment, a sales target confirms any type of requested interaction accepted by a rep. A confirmed accepted interaction automatically receives a status of “scheduled.” Notice is transmitted to the rep upon a “scheduled” indication of an interaction.

In an embodiment, the scheduler comprises incremental scheduling options, such as but not limited to 1-hour increments. The scheduler comprises the ability to designate an interaction as “one-time” or “recurring.” Recurring interactions are duplicated on the schedule at the given recurrence interval, such as days, weeks, months, etc. The sales target user uses the system to designate interaction type, such as “meal/snack,” “service call,” “meeting,” and the like. The user sets the calendaring period available for associated reps to schedule an interaction. In an embodiment, the period is six months, but any time period may be designated.

A sales target accesses the online calendar using the system. The sales target is provided a typical calendar page with time slots that may be viewed in days, weeks, months, other periods and the like. The sales target user selects a period for rep interaction, such a time span on a given day of the week, and designates a start and end for a given type interaction, such as a meal/snack, service call, and the like, and sets the recurrence of the interaction opportunity on the calendar. The sales target indicates the frequency of recurrence of the interaction, such as weekly, bi-weekly, monthly, etc. The sales target repeats the selection of a new period and recurrence until all availability of the sales target is recorded. The sales target selects the maximum number of associated reps that may be scheduled into each period of interaction opportunity.

As depicted in FIG. 3, a sales target accesses the system to determine information about one or more rep in a generalized rep database 87 and or in a database of reps associated with that sales target 88. The sales target designates 87a one or more rep listed in the generalized database to be included in the sales target's database of associated reps (i.e., listed reps). In addition to defining generalized opportunities for rep self-scheduling, a sales target optionally sends 88 a specific appointment offer or meeting request to a specific rep. E-mail messages may be used to offer one or more appointment, to make one or more request of, and or to reply to one or more response of one or more associated rep.

The rep accesses and views scheduling availability 89 for an associated sales target and schedules one or more events with one or more selected sales target in accordance with any applicable limitations, such as scheduling horizon limits, limits on the number of scheduled interactions that a rep is allowed for a specified period of time, a scheduling blockade imposed by a sales target for a specific rep, and the like. To accept an opening for an interaction offered by a selected associated sales target, a rep optionally views archived information 89a for the selected sales target and may optionally overlay a display of his/her schedule with openings for the selected sales target 89a. In a preferred embodiment, a rep may opt to superimpose a display of interactions that related reps (e.g., sales teammates) have scheduled with the selected sales target. A meeting request or appointment offer becomes a scheduled interaction for sales target and rep when accepted by the rep, which the sales target may view 90 along with unaccepted interaction openings and unaccepted appointment offers. Both sales targets and reps view and update 91, 92 the electronic display of their respective schedules.

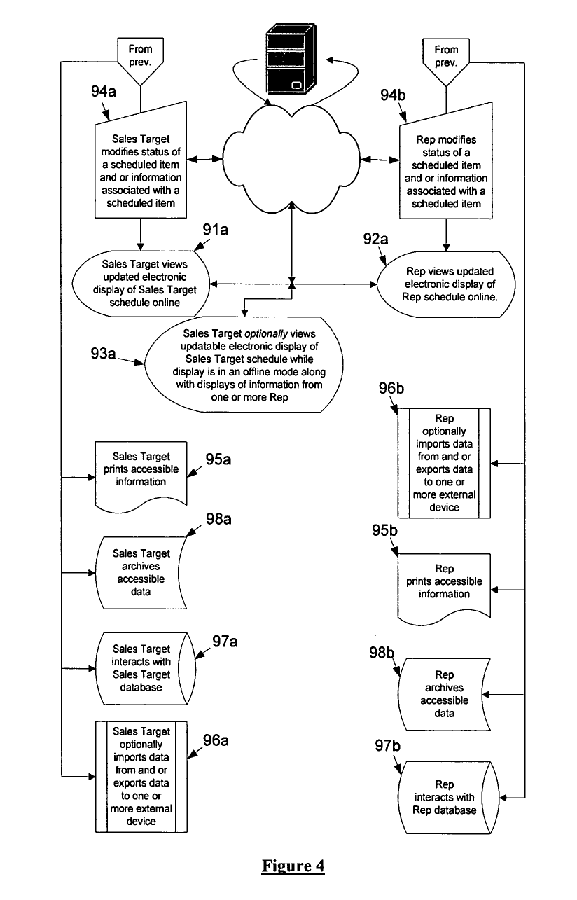

Referring to FIG. 4, each of a sales target and a rep may modify 94a, 94b the status of a scheduled event and or information associated with a scheduled item. Both sales targets and reps may view any modified 91a, 92a event(s) on their respective updated schedules. A sales target optionally views 93a an updatable electronic display of that sales target's schedule while said display is in an offline mode. The offline display further comprises information stored in the database 600 or linked to the system.

Scheduled interactions and interaction openings may be viewed, edited, changed and or cancelled by the sales target. Reps cannot edit and or change an interaction or an interaction opening, but may cancel an accepted opening. In an embodiment, the system provides one or more icon for use as an indicator in the calendaring component. When a sales target user creates openings for desired interactions, an icon indicating interaction type (e.g., “service call,” “meal/snack,” “meeting,” etc.) is automatically associated with the display of available time(s) for the interaction opening(s) created. The display of available times is accessible by the sales target and related sales targets, and reps associated with the sales target. The display accessible by a rep is optionally in a format that is different from the display format accessible by a sales target. For example, an available time displayed to a rep may not incorporate icon(s) indicating interaction type.

The sales target optionally uses the system to indicate one or more specific day that interactions are not available in the designated date range. The sales target optionally cancels future recurring interactions and receives notification of affected interactions. After a cancel has been initiated, the system displays a list of interactions affected, cancels the interactions, and prepares and transmits an email to the rep for notification or action, such as to reschedule. The system prevents any further interactions from being scheduled during the unavailable period specified by the sales target user. By using the system, “cold calls” are limited to specific day(s) and time period(s) and the number of reps that may accept an opening for a scheduled “cold call” is likewise limited.

The following is an example of the calendaring component of the system.

### EXAMPLE III

In this example, a healthcare sales target inputs preferred times that one or more physician or other type of sales target in an office is designated to be available for a service call by an associated rep. “Service calls” are brief, service oriented visits grouped as to specific staggered time periods defined by the sales target. Settings for the service call allow the sales target to determine how many reps may appear at the sales target office during each open period.

A sales target may offer interactions, including a “meal/snack.” A sales target creates and posts a “meal/snack” interaction offering when interested in having a meal/snack meeting with an associated rep bringing food to the sales target. The sales target may expect sales information during the lunch, breakfast, coffee break, or the like. The sales target user uses the personnel list to assign staff to an offering of a meal/snack interaction. Sales target information displayed for reps to view for each meal/snack opening includes number of attendees, names, titles, food/restaurant preferences, and the like. In an embodiment, the scheduler limits acceptance of a posted meal/snack opening to one rep. A rep accepting an invitation to a posted meal/snack opening optionally uses information specific to that sales target located on the system to make presentation plans and to order food from a preferred restaurant for the number of staff attending the meal/snack meeting. The information of a rep accepting a meal/snack opening together with any linked information from the accepting rep is viewable and printable by the sales target and is optionally e-mailed. Optionally, the system provides external information regarding a meal/snack interaction opening. As an example, a link to one or more caterer and or restaurant that provides online ordering is provided so that a rep may supply food for an interaction with increased efficiency and convenience.

The following example further describes the “meal/snack” component of the scheduler.

### EXAMPLE IV

A sales target user that typically has interactions with reps, such as lunches provided by reps to market products/services, designates lunch availability preferences. In this example, the sales target is a healthcare office, but any sales target is applicable. The scheduling tool is used by a healthcare office to efficiently allocate available time slots during which one or more pharmaceutical rep may come to the office to make a sales call. The office selects one or more series of blocks of open time for one or more associated reps to schedule time for meetings, lunches, service calls and the like with the office. In this example, the office sets the days and times available for lunches to be scheduled by reps. The office also indicates which physicians and or staff members are typically in the office for each lunch availability by selecting from a personnel list created as the office information was populated. The sales target user also indicates how many people the rep should expect at the lunch, menu preferences, and can designate the number of minutes that a rep has available prior to a scheduled lunch to set the lunch up, the amount of time a rep has to make a sales presentation if restricted and or how long a rep is permitted to stay after the lunch is over if this is permitted.

In the example, the sales target creates a list of favorite menus including restaurant name and phone number at a website of the system. The sales target optionally designates special dietary needs/preferences for given office staff so that the rep can accommodate without spending time to make a phone call. The system optionally provides a pull down menu with dietary needs for use by the sales target or alternatively, the sales target may input the needs without a pull down menu.

Where the interaction is a service call, the scheduler allows more than one service call period to be scheduled in a time interval, such as a day, week, and the like. In an embodiment, the scheduler component of the system allows multiple service call periods per day. The sales target controls the minimum time span of a posted service call period. In an embodiment, the time span generally recommended is 1 hour, but any time span may be used. The system allows more than one opening for an associated rep to accept to be posted within a service call period. The sales target specifies the number of rep openings to be posted within a posted service call period.

In an embodiment, the system provides one or more “opportunity” icon for use as an indicator in the “service call” (i.e., drop-in visit) scheduling component. When a sales target specifies the number of openings for a service call period, a discrete opportunity icon viewable by the sales target, related sales targets, and optionally by reps associated with the sales target indicates each service call opening that has been specified. The total number of opportunity icons displayed is the same as the finite number of reps designated by the sales target user to be permitted to drop-in during the time specified for the service call period. In an embodiment, an opportunity icon is displayed as a diamond shape inside an area showing as a service call period in a calendar view.

A rep desiring to make a service call upon a given sales target interacts with one of the user-designated openings for service call interaction to accept a designation for the opportunity to visit the office during the time period for that posted interaction. Upon such acceptance of a designation by the rep, the system changes the icon appearance to show that the finite number of available designations has been reduced by one; this change in icon appearance repeats for each rep accepting a service call designation. In an embodiment, the change in icon appearance is that of a diamond shape with an open center changing to a diamond shape with a filled-in center. Upon the acceptance of all of the openings designated for a given time period, no more reps may accept a designation for that time period. The information of each rep accepting a designation in a service call period is linked to the calendaring mechanism and is viewable, printable, and e-mailable by the sales target.

The following example illustrates the service call component of the scheduler.

### EXAMPLE V

A sales target user creates a service call period using the scheduler. The service call period spans one hour on a given day. The sales target designates the number of reps that can fill the service call period. In this example, the sales target creates three rep openings in the service call period. A rep, with access to the system and an association with that sales target, who has an interest in visiting that office at that time and on that day, accepts one of the three rep openings for that service call period. When the number of reps accepting an opening in a given service call period equals the number of openings designated by the user for the period (3 in this example), interaction openings for said period will no longer be visible to reps looking for service call openings with this sales target. By accepting an opening, the rep sets the expectation that he/she will arrive at the sales target location during the time span designated as the service call period. The rep is aware that other reps who have accepted openings for that service call period will likely be dropping in to visit the sales target during that time frame, but the rep can be certain that his/her visit will be accommodated by the sales target and can be relatively certain that sales target personnel will be available to talk with that rep during that time period. In a preferred embodiment, a rep will optionally be able to know how many rep openings have been designated by the sales target for a given service call period and how many of those openings have been accepted by other reps.

Appointments with associated reps are optionally requested by a sales target. Interactions are constructed based on the needs of the sales target. A sales target uses the system to request an appointment for a meeting or other type of scheduled interaction with a particular associated rep. In an embodiment, the sales target selects the interaction type and the desired time and day using the scheduler and transmits the request to a rep selected from the sales target's list of associated reps. Alternatively, the rep includes a link in the rep's information area, which allows a sales target to request a meeting or other interaction with that rep based on information posted at that site. Appointment requests optionally include messages from the sales target asking about a certain product/service the rep's company sells. In an embodiment, when a rep has a new appointment request from a sales target, a visual alert is displayed to cue the rep upon the rep's login to the system.

Additionally, a rep may elect to have an alert message sent to a specified e-mail address whenever the rep has a new appointment request from an associated sales target. The rep accesses the system and accepts, declines, or suggests alternative times for the meeting. Alternatively, the rep calls the sales target requestor to discuss the appointment request. Upon receiving a suggestion from a rep for an alternate meeting time whether via the system or by phone, the sales target or a related sales target accesses the system to modify or cancel the original appointment request; and the rep subsequently accepts the modified request. Scheduled appointments and associated information, such as the rep's profile information and sales target information are linked to the event and may be viewed by the sales target and or the specific rep. The rep optionally adds comments viewable by the sales target and the rep to any accepted meeting or other type of scheduled interaction. An embodiment of the invention provides means for e-mailing a meeting request or notice, and or schedules, information, and the like.

A sales target may edit a scheduled appointment. A rep cannot edit a scheduled appointment, but may decline or cancel the appointment. When an accepted appointment is cancelled by either a rep or a sales target, a notice is optionally transmitted to the cancellee. In an embodiment, if the cancellation occurs in a given time period prior to the meeting, notice is automatically sent to the cancellee. In a preferred embodiment, the time period for automatic notification is 7 days. An embodiment of the system provides the canceller the opportunity to add comments to the default cancellation message.

The scheduler of the system comprises means to associate one or more tag with an interaction. In an embodiment, a sales target user uses a tag to specify the rep as a “no-show” when the rep fails to attend an interaction. Tags may be used to create reports. An embodiment comprises means for a sales target user to enter a comment on the rep's profile. The system comprises means to optionally generate notice to the “no-show” rep and or the rep's company.

The system comprises a search engine. The invention provides a user the means to filter information based on criteria such as but not limited to the user's area of business, channels of commerce, and specifics, such as specialty, interests and the like. A user uses the search engine to search for specific information located within or linked to the system. In an embodiment, searches are constructed using conventional boolean means, but one skilled in the art would understand that any existing or future search means may be substituted and employed.

A rep uses the search engine to search the general database of sales targets using the system or the list of that rep's associated sales target(s) to locate a specific sales target by name, address, demographic, or other such category. Similarly, a sales target uses the search engine to search the general database of reps using the system or the list of that sales target's associated reps to locate a rep for a specific product, company, demographic, or other such category.

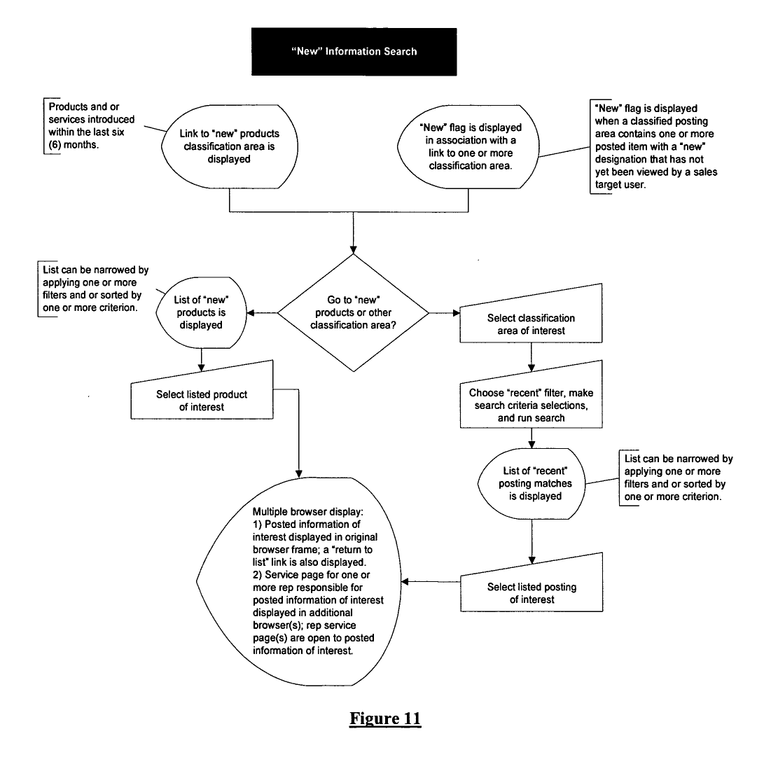

FIGS. 11-14 depict embodiments of the invention using the search engine component. In an embodiment, a sales target uses the search engine to find information and or offerings of an associated rep. In an embodiment, the sales target uses the system of the invention to select the rep from the sales target's list of associated reps or from a search for information and or any type of offering of one or more rep based on a specific product or service, company, interest area, and or other such category. To ensure that sales target searches of information posted by reps produce a result, the system requires all information posted to be linked with one or more uniformly standardized category designators. The system uses standard category designations by which sales targets using the search engine locate rep information. The system provides reps with product and service name selection lists to minimize inadvertent misspellings of product or service names to be associated with information postings. The system requires the use of standard category designations by sales targets for reps using the search engine to locate sales target information.

The following example is used to illustrate the search engine component of the invention.

### EXAMPLE VI

A sales target, such as a physician or a staff person in the physician's office, is interested in obtaining information. In this example, the desired information is an instructional video detailing the steps and requirements for injecting a specific drug. Using the search engine of the present invention, the user searches the office roster of reps or the rep resource listings by the specific drug name. The results of the search comprise one or more hyperlinks representing reps associated with companies marketing the specific drug. The hyperlinks may further comprise additional information concerning the drug and/or the rep and or the rep's company. Information may comprise general information, such as a contact telephone number, web address or site and specific information, such as the next scheduled visit by that rep to the user's office, additional product or service information and related offerings. The user then uses the system to download and or view a digitized video presentation file or to contact the rep, such as by sending a message to the rep by selecting that link located on the system. Using the link, the user executes a download or a play operation or requests a video of injection procedures for the specific drug. Upon receipt of information about the sales target downloading or playing the video or upon receipt of a request message, the rep uses the system to determine any information about the user interacting with the video or making the request, such as but not limited to location, listed personnel, user meal/snack preferences, and the like. The rep optionally posts alerts to sales targets regarding products, such as those approved for a new indication and or new resource offerings such as the video discussed in this example.

Information, as applied to the physician in this Example VI, includes but is not limited to an eye or growth chart, samples, coupons or vouchers, treatment regimes, drug delivery instructions, indications, patient information, publications, such as study results, product reimbursement, such as Medicare/Medicaid, and the like. One skilled in the art would understand, however, that the invention is useful for requesting any type of information from any rep marketing to any sales target.

In an embodiment where the sales target uses the system to request sample deliveries, the user optionally 1) searches the sales target's list for a rep marketing that product and or 2) uses the system's search engine to search the database of information posted by associated rep(s) for a particular product sample posting and or 3) uses the system's search engine to search the general rep database by product name. The system's search engine produces a page of links to results found for the searched item. The links are to rep information located on the system. Using the link, the sales target (after an association is designated with that rep) sends a message to the rep requesting the samples delivery. The system comprises means to transmit rep information to the sales target as text within an e-mail body. Alternatively, the sales target may use the rep contact information located on the system to contact the rep directly by telephone, e-mail, and or other means of communication.

A sales target or a registered rep optionally uses the search engine to locate a rep or sales target. The user searches by inputting a zip code, state, and or name (i.e., product name, company name, professional group name, etc.) to determine reps or sales targets using the system. The user optionally saves search results to a file including links to the information. The file is editable.

As shown in FIG. 4, the system comprises a print function 95a, 95b for sales target(s) and for rep(s). The print function is useful for printing, tracking disseminating, and or posting data, such as interactions, information, and the like. Information is optionally linked to one or more interaction. In an embodiment, a sales target prints a daily schedule of the rep hosting that day's meal/snack period(s) if any and any service call period(s) with sales reps that have indicated a service call during period(s). Meetings and or events that involve individually named personnel of the sales target that the sales target has requested or has sent an RSVP to attend also print on the daily schedule as well as names or brief descriptions of the personnel or parties involved and the purpose of the appointments. A sales target has the option of printing daily schedules that will “communicate” information about the reps calling on that office each day, i.e., their products, product blurbs, etc. The “print communication,” function allows the sales target to avoid printing the screen itself, which is not designed for offline print viewing.

The system links information posted by a rep to events scheduled by that rep. The linked information is optionally printed with the schedule. A user may also print information separately from the schedule. The linked information comprises demographic information, such as a picture of the rep; general information, such as information about the rep or his/her company; and or specific information, such as information regarding a new drug, and the like. Data is printed or optionally exported to a second device 96, 96a, such as but not limited to a PDA.

Returning to FIGS. 3 and 4, a sales target optionally interacts 97a with a database to input information and or allocate and block 80, 83 time for one or more interaction opening. A rep optionally interacts 97b with the database to access demographic and or other information pertaining to one or more sales target. The system may optionally be interfaced with one or more rep database to facilitate the importing and exporting of data between a rep database and a system database.

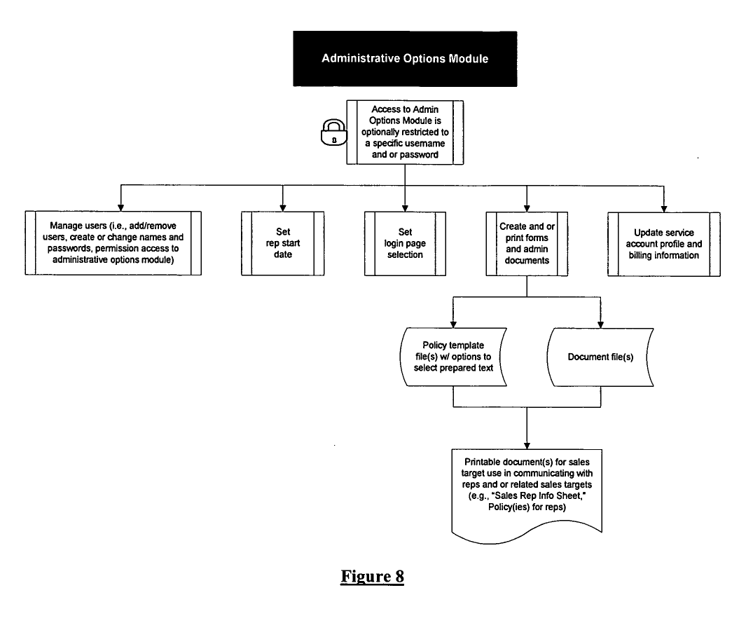

As depicted in FIG. 8, the system allows the sales target to optionally input and or create an interaction policy for use by the rep. In an embodiment, a healthcare office optionally inputs an existing policy with or without modification or creates a new policy and may use template(s) and or language selections provided by the system to facilitate policy creation. The policy may be useful to support compliance with a government guideline and or regulation. The policy may be printed by users for future reference. The system allows a sales target to make changes to the policy as required or desired.

The system comprises means to track 98a, 98b the use of the system by one or more user. The system comprises means to prevent access by a user or a group of users through the security device 800.

The system comprises means to create one or more report from data stored in the database 600 and or linked to the system. Reports for sales target users include, but are not limited to, a prospective and or retrospective schedule activity report, such as a view of all interactions by day, week or multiples thereof, rep information, such as a roster and or favorite, limited or restricted, inactive, etc. reps, and the like. Alternatively, a report for a sales target is created based on other criterion, such as by rep, product category, pending interactions, accepted and confirmed interactions, “no-shows” and the like. A sales target user uses the report feature of the system to create lists of reps and or companies, which can be filtered by varying search factors. A sales target user uses a listing of office personnel to forward a designated report to designated personnel. Reports for rep users include, but are not limited to, a prospective and or retrospective schedule activity report for a rep and or one or more rep teammate, such as a view of all interactions by day, week or multiples thereof, sales target information, such as a roster and or rated, limited or restricted, etc. sales targets, and the like. Alternatively, a report for a rep is based on other criterion, such as by rep territory, sales target, demographic classification(s), profiling designation(s), pending interactions, accepted and confirmed interactions, comment card responses, special situations and the like. A rep uses the report feature of the system to create lists of sales targets and or sales target affiliations, which can be filtered by varying search factors. A rep uses a listing of rep personnel to create a designated report and or forward a report to designated personnel. A rep optionally accesses system-wide data to generate reports of aggregated sales target and or aggregated rep data comprising related and or unrelated reps.

The system further comprises means to view the status of an account. Access to view account status information may be controlled via passwords, location, terminal, and the like.

An embodiment of the invention allows a sales target to limit all reps in general or one or more specific rep. The sales target designates the number of interactions that all reps or a given rep can schedule with the sales target during a given period, or, alternatively, the sales target limits the rep(s) indefinitely. In an embodiment, notice of a generalized limiting is given to a rep when an attempted action via the system would result in a violation of a limit established by a sales target; notice of a limiting applicable only to a specific rep is transmitted to the limited rep if the sales target designates notification. Limits are designated for a particular rep for a given type of interaction, such as service calls and or meal/snack, or alternatively, for all interactions. Limits for requested meetings, if any, are incorporated in the meeting request. The system comprises means to restrict access to a particular user. Alternatively, the sales target uses the system to provide a particular rep first choice for interactions. A sales target optionally accesses a rep service page to access an interactive form, such as a comment card, to rate that rep. The system collects the rating information for reports to the rep and or the rep's company.

An embodiment of the present invention comprises one or more rep tool to personalize scheduled and online interaction with sales targets. An embodiment comprises the offering of information specific to a sales target, such as, in a preferred embodiment, a physician and that physician's office staff. In an embodiment, a sales target may personalize information and ensuing interactions with one or more rep.

The present invention comprises means to display information on one or more digital media receiver 206, 206n located at a sales target. The digital media receiver 206, 206n is similar to those well known in the art. The digital media receiver 206, 206n is coupled to the system, the system databases 304, 304n, 600, and information external to the system. Displayed information is that specific to the sales target, such as a day or other period of the calendar of the system, rep information associated with interactions scheduled for the day or period, and or other information, such as advertisements for products promoted to the sales target by a rep/rep company, educational information and the like. The displayed information is compiled and or stored in a storage file located on the digital media server 700 of the system. Information specifying layout, such as the arrangement of the display on separate pages is included in the file or linked to the file. Alternatively, the file designates information located on the system to be transferred to the sales target. The file designates the sequence of the information transmitted. It will be appreciated that the file determining the displayed information may include additional information not located on the system that a file management system obtains from a remote location prior to the transmission of the information. In an embodiment, a sales target selects personal interests as additional information, such as but not limited to news, music, sports, travel, cooking and other special interest information, family photos, and the like.

In an embodiment where the information displayed at the digital media receiver 206, 206n is selected by the sales target; the target optionally determines the content, layout, timing, and or sequence of the pages. Alternatively, some or all of the information is selected by a second party, such as a rep/rep company, or other entity associated with the system.

The device storage file contains a unique sales target name and a unique full path name for delivery of the file with optional additional information specific to the digital media receiver linked by the file management system. The CPU of each digital media receiver has a unique serial number that is associated with a specific sales target. The file management system distributes the storage file to the digital media receiver of the specific sales target at a designated time. In an embodiment, the time is a time during which the sales target is closed. The storage file is automatically updated every 24 hours, 7 days and the like based on the designations in the storage file and or information stored and accessible on the system. In an embodiment, the display information comprises the scheduled reps visiting the sales target for that period, such as a day, a week and the like, with scheduled rep information, including but not limited to name, company, product, photo, and the like.

The digital media server 700 comprises means to broadcast information to all digital media receivers. Alternatively, the broadcast is a “narrowcast” to preset groups of digital media receivers with a group being as small as one (1) in some cases. In an embodiment, broadcast information is associated with a sales target's industry, and is specific information relative to the industry, such as but not limited breaking news, alerts, reminders, advertising, information about new or targeted products/services, and the like.

One skilled in the art would understand that the digital media receiver would be capable of receiving any form of digital information, such as digital images, media, video, audio, and software files, such as a word processing file. The digital media receiver optionally supports 2-way connectivity with the database 600 and system server 150. Sales target key strokes, touch screen interaction, and the like can cause information to be uploaded to the database 600 at the time that a connection to the system is established to download information from the digital media server 700 to the digital media receiver. In an embodiment, a rep offers product samples to one or more sales target via a digital media receiver display; a sales target requests the samples being offered via a button that is a part of the digital media receiver unit; the request is subsequently uploaded to the database and transmitted to the rep by the system server 150.

The present invention further comprises wireless devices used to transmit and receive electronic information. In an embodiment, the system combines information transmitters, such as a smart card, programmed implantable chip, handheld device and the like with the components of the system to notify the system of specific information. The information may be contained on the transmitter or a code that is linked to information stored remotely.

The following illustrates an example of combined components.

### EXAMPLE VII

In this example, the sales target is a patient of a physician, who is the rep. The sales target has a device, such as a VeriChip, implanted in his/her body. Upon implantation, the patient uses the scheduler of the system to create openings for appointments. The physician uses the system to accept appointments with one or more patient. The patient may have one or more physician; therefore, one or more physician reps may schedule appointments with the patient. The patient uses the system to search for one of his/her physician using the system to request an appointment with that physician. The request may be for a routine visit, to discuss a new treatment, and the like. A physician may use the system to search for patients with a particular medical condition and or disease based on the information associated with the implanted device to schedule appointments. The scheduled appointment includes information such as new drugs and or treatments specific to that patient, changes in insurance coverage and the like.

In an embodiment, the system interacts with the transmitter in real time. The following example illustrates this embodiment of the system.

### EXAMPLE VIII

A physician and the patient are users of the system. The physician has a digital media receiver linked to the system located in his patient exam or waiting room. The patient has an implanted programmable device linked to the system. When the patient enters the exam or waiting room of the physician, the implant transmits information about the patient to the media receiver, which transmits the information to the server. The server links the transmitted information to a file on the database specific to that patient, such as disease state. The system gathers information stored on the system and or linked to the system based on the information stored in the file, and transmits the gathered information in real time to the media receiver. The media receiver displays the information to the patient. The information may include new treatments for the patient's disease, drug interaction information, results of clinical trials, insurance coverage changes, and the like.

One skilled in the art will understand that the description of the present invention herein is presented for purposes of illustration and that the design of the present invention should not be restricted to only one configuration or purpose, but rather may be of any configuration or purpose which essentially accomplishes the same effect.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

What is claimed is:

1. A system of scheduling events and linking information to the events comprising:
a server with one or more computing component connected to a network, said server comprising a scheduler and a server database;
one or more sales target connected to the network and optionally connected to one or more related sales target through the network or through a second network, said sales target accessing the server through a security component, said security component comparing security information supplied by the sales target to sales target information contained in a sales target file stored in the server database, said sales target 1) inputting sales target information to be stored in the sales target file; 2) using a search component to discover one or more rep and or one or more sales target connected to the network and to optionally create an association with one or more rep, said association a linking of the sales target information to one or more rep information stored in the server database; 3) using the scheduler to offer, modify, confirm and or determine a status of an event, said event electronically linked to sales target information and selected from the group of an interaction and an appointment, said interaction acceptable by more than one associated rep, said appointment acceptable only by an associated rep selected by the sales target; 4) using the search component to a) determine information related to one or more associated rep and b) using an e-mail component to transmit one or more e-mail message to one or more associated rep; and 5) optionally disassociating with one or more associated rep, said sales target comprising computing means to archive, print, and retrieve information related to one or more associated rep; said sales target optionally 1) comprising means to import data from and or export data to one or more external device; and 2) interconnected to a digital media receiver receiving one or more operating system control file and one or more media file from a media transmitting component of the server; and,
one or more rep connected to the network and optionally connected to one or more related rep through the network or through a second network, said rep accessing the server through the security component, said security component comparing security information supplied by the rep to rep information contained in a rep file stored in the server database, said rep 1) inputting rep information to be stored in the rep file; 2) using a search component to discover one or more sales target and or one or more related rep connected to the network; 3) creating an association with one or more sales target and or optionally with one or more related rep, said association a linking of the rep information to one or more sales target information and or related rep information stored in the server database; 4) optionally selecting one or more associated sales target to enable the rep to a) access and view archived information for one or more selected associated sales target, said archived information selected from the group of sales and service interaction history with the selected associated sales target, b) post targeted information on a web page for one or more selected associated sales target, and c) use an e-mail component to email one or more selected associated sales target; 5) optionally selecting one or more associated related rep to enable the rep to a) access and view associate information for one or more selected associated related rep, said associate information selected from the group of sales and service interaction of the selected associated related rep with one or more sales target associated with said selected associated related rep, b) post information on a web page for one or more selected associated related rep, and c) use an e-mail component to email one or more selected associated related rep; 6) using the scheduler to a) view one or more interaction and or one or more appointment offered by one or more associated sales target, b) electronically accept one or more interaction and or one or more appointment offered by one or more associated sales target, said accepted interaction and or accepted appointment electronically linked to rep information, c) view a status of the interaction(s) and or appointment(s) accepted by the rep, d) modify the status of an accepted interaction and or accepted appointment, e) electronically compare one or more interaction and or appointment offered by one or more associated sales target with the associated rep's schedule and use the comparison to accept one or more offered interaction and or appointment, and f) optionally add and or modify a rep annotation for one or more accepted event; 7) responding to one or more e-mail message using the system; and 8) optionally disassociating with one or more associated sales target or associated related rep, said rep comprising computing means to archive, print, and retrieve information related to one or more associated sales target, one or more selected associated sales target and or one or more related rep; said rep optionally comprising means to import data from and or export data to one or more external device; said server optionally interacting with the scheduler to a) request a confirmation from the rep that accepted one or more sales target posted meal/snack appointment seven days prior to the date of the appointment, b) notify the sales target when the rep responds to the confirmation, and c) notify one or more upgraded rep when one or more sales target first accesses the network, wherein said first accessing sales target inputs an address in the sales target information, said address included in a territory inputted in the upgraded rep information.

2. The system of claim 1 wherein the rep is a pharmaceutical rep and the sales target is a healthcare provider.

3. The system of claim 1 wherein the associated sales target determines a set number of openings for the interaction, said opening acceptable by one associated rep.

4. The system of claim 1 wherein the rep has a set period of time to electronically accept one or more interaction opening and or one or more appointment offered by one or more associated sales target.

5. The system of claim 1 wherein the accepted interaction is selected from the group consisting of meal/snack, drop-in visit and flexible event.

6. The system of claim 1 wherein the accepted appointment is selected from the group consisting of meal/snack, presentation, seminar, conference, and meeting.

7. The system of claim 1 wherein the inputted sales target information comprises general information and specific information, said specific information selected from the group consisting of personnel details, business affiliations, policies, food preferences, guidelines, e-mail messages, archived files of messages, and information regarding dealings with one or more associated rep.

8. The system of claim 1 wherein the inputted rep information comprises one or more digital photograph of the rep, one or more digital product logo, general information and specific information, said specific information comprising educational material, promotional material, marketing material, and one or more link to external information.

9. The system of claim 8 wherein the rep information is viewable as a web page.

10. The system of claim 9 wherein a network system administrator extends a set period of time for one or more rep in response to one or more request for an upgrade in network status, said upgraded rep optionally tagging one or more sales target, said tagging via a code input by the sales target upon access to the network, said tagged sales target displayed the upgraded rep's web page during access to the network and wherein a) more that one upgraded rep's web page is displayed to said tagged sales target on a rotational schedule if more than one upgraded rep tags the sales target, and b) reps other than upgraded reps tagging the sales target cannot access the tagged sales target information for a designated period of time.

11. The system of claim 10 wherein the scheduler automatically accepts one or more opening for the upgraded rep, said automatic acceptance established by the upgraded rep selecting a repeat option over a predetermined span of time.

12. The system of claim 11 wherein the scheduler notifies the upgraded rep when an automated repeat acceptance for the upgraded rep is not available.

13. The system of claim 8 wherein specific information is information about one or more product offered by the rep, said one or more product optionally comprising a mechanism denoting the product as a new product for a predetermined period of time.

14. The system of claim 13 wherein the product is one of a drug, a medical device and a service offered to a healthcare facility and or a patient.

15. The system of claim 1 wherein the media file comprises data selected from the group of one or more daily schedule of offered and or accepted interactions and or appointments for that associated sales target, rep information for associated rep(s) that accepted the interactions and or appointments, advertising information, information about upcoming events, education information, and information of personal interest.

16. The system of claim 1 wherein the information of personal interest is selected from the group sports information, arts information, financial information, travel information, cooking information, and digital photographs.

17. The system of claim 1 wherein offered and or accepted interaction and or appointment activity is 1) logged and archived by a server logging component, and 2) optionally sorted by a server sorting component and reported by a server reporting component.

18. The system of claim 1 comprising one or more wireless device interconnected to the network.

19. The system of claim 18 wherein the wireless device communicates a code to the receiver, said receiver communicating the code to the server, said server transmitting information linked to the code to the receiver, said receiver displaying the linked information.

20. A method of scheduling events and linking information to the events comprising the steps of:
1) one or more sales target optionally interconnected to one or more related sales target and one or more rep optionally interconnected to one or more related rep, each connected to a network accessing a server comprising computing components, said server connected to the network;
2) one or more sales target and one or more rep providing information;
3) the server storing the sales target information in a sales target file and storing the rep information in a rep file;
4) one or more sales target locating and accessing one or more sales target information and or rep information and optionally creating an association with one or more rep, said association a linking of the sales target information to one or more rep information stored in the server database, and or one or more rep locating and accessing one or more related rep information and or one or more sales target information and creating an association with one or more sales target and or optionally with one or more related rep, said association a linking of the rep information to one or more sales target information and or related rep information stored in the server database, and optionally (A) selecting one or more sales target to enable the rep to a) access and view archived information for one or more selected associated sales target, said archived information selected from the group of sales and service interaction history with the selected associated sales target, b) post targeted information on a web page for a selected associated sales target, and c) use an e-mail component to email the designated associated sales target, and or (B) selecting one or more associated related rep to enable the rep to a) access and view associate information for one or more selected associated related rep, said associate information selected from the group of sales and service interaction of the selected associated related rep with one or more sales target associated with said selected associated rep, b) post information on a web page for one or more selected associated related rep, and c) use an e-mail component to email one or more selected associated related rep;
5) the associated sales target allocating and posting one or more event having associated sales target information linked to the event using a server scheduling component, said event selected from the group of an interaction and an appointment, said interaction acceptable by one or more than one associated rep, said appointment targeted to a selected associated rep;
6) the associated rep viewing only those interactions and or appointments offered by one or more associated sales target;
7) the associated rep accepting one or more viewed interaction and or appointment; said accepting linking associated rep information to the accepted interaction and or accepted appointment;
8) the associated sales target viewing the associated sales target's schedule depicting the accepted interactions with linked associated rep information and or accepted appointments with linked associated rep information, and the associated rep viewing the associated rep's schedule depicting the accepted interactions with linked associated sales target information and or accepted appointments with linked associated sales target information;
9) the associated sales target modifying, updating, canceling and or confirming one or more offered and or accepted interactions and or appointments, said modified, updated, canceled and or confirmed accepted interactions and or appointments viewable by the associated rep accepting the interaction and or appointment, the associated rep optionally alerted to said modifications, updates, cancellations and or confirmations of accepted interactions and or appointments via a signal and or a message sent to a rep device;
10) the associated rep optionally a) canceling one or more accepted interaction and or modifying one or more accepted appointment, said canceled accepted interaction and or modified accepted appointment viewable by the associated sales target offering the interaction and or appointment, the associated sales target optionally receiving an alert upon each cancellation and or modification of accepted interactions and or appointments sent to a sales target device designated by the associated sales target; and b) adding and or modifying a rep annotation for an accepted event;
11) the server optionally interacting with the scheduler to a) request a confirmation from the rep that accepted one or more sales target posted meal/snack appointment seven days prior to the date of the appointment and b) notify the sales target when the rep responds to the confirmation, said notification one of an e-mail message and a change in an icon associated with the appointment; and
12) the server and or the associated sales target and or the associated rep optionally archiving, printing, retrieving, and importing/exporting information of an associated sales target and or associated rep.

21. The method of claim 20 wherein the rep creates an interactive service page comprising content comprising information about the rep, information about the rep's company, and information about one or more of the rep's product and or related offerings; said related offerings comprising means for one or more sales target to request and receive an available product, offered item, and or additional information.

22. The method of claim 21 further comprising the step of linking part or all of one or more associated rep's service page to one or more accepted interaction and or accepted appointment.

23. The method of claim 20 wherein the server transmits one or more operating system control file and one or more media file at a determined interval to a digital media receiver interconnected to the sales target, said media file comprising data selected from the group of one or more daily schedule of offered and or accepted interactions and or appointments for the sales target, rep information for associated rep(s) that accepted the interactions and or appointments, advertising information, information about upcoming events, education information, sports information, arts information, financial information, travel information, cooking information, and digital photographs.

24. The method of claim 23 further comprising the step of a wireless device communicating a code to the receiver, said receiver communicating the code to the server, said server transmitting information linked to the code to the receiver, said receiver displaying the linked information.

25. The method of claim 20 further comprising the step of interconnecting one or more rep in a permission-based hierarchy.

26. The method of claim 25 wherein the hierarchy is used to determine the contents of one or more service page, said contents comprising a digital photograph of the rep, a one or more digital product logo, one or more digital company logo, one or more digital coupon, advertising materials, educational materials, news, one or more product/service offering, and one or more hyperlink to external information.

27. The method of claim 26 wherein the contents are determined by the sales target information of each associated sales target.

28. The method of claim 20 wherein sales target information and or rep information is electronically marked with one or more standardized navigation label for use by a search and or sort component.

29. The method of claim 20 further comprising the steps of
a network system administrator extending the set period of time for one or more rep in response to one or more request for an upgrade in network status;
the scheduler automatically accepting one or more opening of one or more associated sales target for the upgraded rep, said automatic acceptance established by the upgraded rep selecting a repeat option over a predetermined span of time;
the scheduler notifying the upgraded rep when an automated repeat acceptance for the upgraded rep is not available;
the upgraded rep optionally tagging one or more sales target, said tagging via a code input by the sales target upon access to the network, the server displaying a web page of the upgraded rep to the tagged sales target upon access to the network and wherein a) the server rotates the displayed web page where more that one upgraded rep tags the sales target and b) the server prevents access to tagged sales target information by reps other than upgraded reps tagging the sales target for a designated period of time; and
the server optionally notifying one or more upgraded rep when one or more sales target first accesses the network, wherein said first accessing sales target inputs an address in the sales target information, said address included in a territory inputted in the upgraded rep information.

30. The method of claim 20 wherein the associated rep electronically compares one or more interaction and or appointment offered by one or more associated sales target with the associated rep's schedule; and wherein the associated rep accepts one or more offered interaction and or appointment based on the comparison.

31. The method of claim 20 wherein a server logging component logs and archives offered and or accepted interaction and or appointment activity, said logged activity is optionally sorted by a server sorting component and reported by a server reporting component.

32. A system of electronically offering and accepting an event having digital information linked to the event comprising:
a server with one or more computing component connected to a network, said server comprising a scheduler and a server database;
one or more sales target connected to the network and optionally connected to one or more related sales target through the network or through a second network, said sales target accessing the server through a security component, said security component comparing security information supplied by the sales target to sales target information contained in a sales target file stored in the server database, said sales target 1) inputting sales target information comprising general information and specific information, said specific information selected from the group personnel details, business affiliations, policies, food preferences, guidelines, e-mail messages, archived files of messages, and information regarding dealings with one or more associated rep, said sales target information updateable and stored in the sales target file; 2) using a search component to build a search using one of name, geographic and or demographic data to discover one or more rep and or one or more sales target connected to the network and to optionally create an association with one or more rep, said association a linking of the sales target information to one or more rep information stored in the server database; 3) using the scheduler to offer, modify, confirm and or determine a status of an event, said event electronically linked to sales target information and selected from the group of an interaction and an appointment, said interaction either a meal/snack, a drop-in visit or an additional recurring event and having a set number of openings, said opening acceptable by one associated rep, said appointment one of a meal/snack, presentation, seminar, conference, and meeting, and acceptable only by an associated rep selected by the sales target; 4) using the search component to a) determine information related to one or more associated rep and b) transmit one or more e-mail message to one or more associated rep; and 5) optionally disassociating with one or more associated rep, said sales target comprising computing means to archive, print, and retrieve information related to one or more associated rep and or one or more related sales target; said sales target optionally 1) comprising means to import data from and or export data to one or more external device, and 2) interconnected to a digital media receiver receiving one or more media file and an operating system control file from a media transmitting component of the server, said media file comprises data selected from the group of one or more daily schedule of offered and or accepted interactions and or appointments for that associated sales target, rep information for associated rep(s) that accepted the interactions and or appointments, advertising information, information about upcoming events, education information, and information of personal interest, said personal interest information selected from the group of sports information, arts information, financial information, travel information, cooking information, and digital photographs;
one or more rep connected to the network and optionally connected to one or more related rep through the network or through a second network, said rep accessing the server through the security component, said security component comparing security information supplied by the rep to rep information contained in a rep file stored in the server database, said rep 1) inputting rep information comprising one or more digital photograph of the rep, one or more digital product logo, general information and specific information, said specific information comprising educational material, promotional material, marketing material, and one or more link to external information, said rep information updateable and stored in the rep file; 2) using the search component to build a search using one of name, geographic and or demographic data to discover one or more sales target and or one or more related rep connected to the network and to create an association with one or more sales target and or optionally with one or more related rep said association a linking of the rep information to one or more sales target information and or related rep information stored in the server database; 3) optionally selecting one or more associated sales target to enable the rep to a) access and view archived information for one or more selected associated sales target, said archived information selected from the group of sales and service interaction history with the selected associated sales target, b) post targeted information on a web page for one or more selected associated sales target, and c) use an e-mail component to email one or more selected associated sales target; 4) optionally selecting one or more associated related rep to enable the rep to a) access and view associate information for one or more selected associated related rep, said associate information selected from the group of sales and service interaction of the selected associated related rep with one or more sales target associated with said selected associated rep, b) post information on a web page for one or more selected associated related rep, and c) use an e-mail component to email one or more selected associated related rep; 5) using the scheduler to a) view one or more interaction and or one or more appointment offered by one or more associated sales target, b) electronically accept one or more interaction and or one or more appointment offered by one or more associated sales target, said accepted interaction and or accepted appointment electronically linked to rep information, c) view a status of the interaction(s) and or appointment(s) accepted by the rep, d) electronically compare one or more interaction and or appointment offered by one or more associated sales target with the associated rep's schedule and using the comparison to accept one or more offered interaction and or appointment, and e) optionally (i) cancel one or more accepted interaction and or modify one or more accepted appointment and (ii) add and or modify a rep annotation for an accepted event; 6) using an e-mail component to respond to one or more e-mail message; 7) optionally disassociating with one or more associated sales target or associated related rep; and 8) optionally requesting an upgrade from a network system administrator wherein said upgrade prompts the server to a) interact with the scheduler to i) extend the set period of time for the rep to respond to one or more opening posted by one or more associated sales target, ii) automatically accept one or more opening of one or more associated sales target for the upgraded rep when the upgraded rep selects a repeat option over a predetermined span of time, and iii) to notify the upgraded rep when an automated repeat acceptance for the upgraded rep is not available; b) tag one or more sales target when one or more sales target inputs a code, said code used by the server to display a web page of the upgraded rep to the tagged sales target, said tagged sales target displayed one or more web page where more that one upgraded rep tags the sales target; the server blocking access to the tagged sales target information by reps other than upgraded reps tagging the sales target for a designated period of time; and c) notify one or more upgraded rep when one or more sales target first accesses the network, wherein said first accessing sales target inputs an address in the sales target information, said address included in a territory inputted in the upgraded rep information; said rep comprising computing means to archive, print, retrieve, and import/export information; and
wherein a) offered and or accepted interaction and or appointment activity is 1) logged by a server logging component and archived by a server archiving component, and 2) optionally sorted by a server sorting component and reported by a server reporting component; and b) the server optionally interacts with the scheduler to 1) request a confirmation from the rep that accepted one or more sales target posted meal/snack appointment seven days prior to the date of the appointment, and 2) notify the sales target when the rep responds to the confirmation, said notification one of an e-mail message and a change in an icon associated with the appointment.

33. A method of electronically offering and accepting an event having digital information linked to the event comprising:
1) one or more sales target connected to a network and optionally connected to one or more related sales target through the network or through a second network accessing a server connected to the network, said sales target comprising computing means to archive, print, and retrieve information, said server having one or more computing component, said sales target accessing the server through a security component, said security component comparing security information supplied by the sales target to sales target information contained in a sales target file stored in a server database;
2) the sales target inputting sales target information, said sales target information comprising general information and specific information, said specific information selected from the group personnel details, business affiliations, policies, food preferences, guidelines, e-mail messages, archived files of messages, and information regarding dealings with one or more associated rep, said sales target information updateable and stored in the sales target file;
3) the sales target using a search component to build a search using one of name, geographic and or demographic data to discover one or more rep and or one or more sales target connected to the network and to optionally create an association with one or more rep said association a linking of the sales target information to one or more rep information stored in the server database; said rep connected to the network;
4) the sales target using a scheduler component to offer, modify, confirm and or determine a status of an event, said event electronically linked to sales target information and selected from the group of an interaction and an appointment, said interaction one of a meal/snack, a drop-in visit and an additional recurring event and having a set number of openings, said opening acceptable by one associated rep, said appointment one of a meal/snack, presentation, seminar, conference, and meeting, and acceptable only by an associated rep selected by the sales target;
5) the sales target using a search component to a) determine information related to one or more associated rep and b) transmit one or more e-mail message to one or more associated rep;
6) the sales target optionally disassociating with one or more associated rep;
7) the sales target optionally a) importing data from and or exporting data to an external device, and b) receiving one or more operating system control file and one or more media file at a digital media receiver interconnected to the sales target, said media file transmitted from a media transmitting component and comprising data selected from the group of one or more daily schedule of offered and or accepted interactions and or appointments for that associated sales target, rep information for associated rep(s) that accepted the interactions and or appointments, advertising information, information about upcoming events, education information, and information of personal interest, said personal interest information selected from the group of sports information, arts information, financial information, travel information, cooking information, and digital photographs;
8) one or more rep optionally connected to one or more related rep through the network or through a second network accessing the server through the security component, said security component comparing security information supplied by the rep to rep information contained in a rep file stored in the server database, said rep comprising computing means to archive, print, retrieve, and import/export information;
9) the rep inputting rep information comprising one or more digital photograph of the rep, one or more digital product logo, general information and specific information, said specific information comprising educational material, promotional material, marketing material, and one or more link to external information, said rep information updateable and stored in the rep file;
10) the rep using the search component to build a search using one of name, geographic and or demographic data to discover one or more sales target and or one or more related rep connected to the network and to create an association with one or more sales target and or optionally with one or more related rep, said association a linking of the rep information to one or more sales target information and or related rep information stored in the server database;
11) the rep optionally selecting one or more associated sales target to enable the rep to a) access and view archived information for one or more selected associated sales target, said archived information selected from the group of sales and service interaction history with the selected associated sales target, b) post targeted information on a web page for one or more selected associated sales target, and c) use an e-mail component to email one or more selected associated sales target;
12) the rep optionally selecting one or more associated related rep to enable the rep to a) access and view associate information for one or more selected associated related rep, said associate information selected from the group of sales and service interaction of the selected associated related rep with one or more sales target associated with said selected associated rep, b) post information on a web page for one or more selected associated related rep, and c) use an e-mail component to email one or more selected associated related rep;
13) the rep using the scheduler to a) view one or more interaction and or one or more appointment offered by one or more associated sales target, b) electronically accept one or more interaction and or one or more appointment offered by one or more associated sales target, said accepted interaction and or accepted appointment electronically linked to rep information, c) view a status of the interaction(s) and or appointment(s) accepted by the rep, and d) optionally (i) cancel one or more accepted interaction and or modify one or more accepted appointment and (ii) add and or modify a rep annotation for an accepted event;
14) the server interacting with the scheduler to a) request a confirmation from the rep that accepted one or more sales target posted meal/snack appointment seven days prior to the date of the appointment and b) notify the sales target when the rep responds to the confirmation, said notification one of an e-mail message and a change in an icon associated with the appointment;
15) the rep using an e-mail component to respond to one or more e-mail message;
16) the rep optionally requesting an upgrade from a network system administrator; said upgrade prompting the server, the server interacting with the scheduler, the scheduler extending the set period of time for the rep to respond to one or more opening posted by one or more associated sales target, and automatically accepting one or more opening of one or more associated sales target for the upgraded rep when the upgraded rep selects a repeat option over a predetermined span of time, the server notifying the upgraded rep when an automated repeat acceptance for the upgraded rep is not available; the server tagging one or more sales target when one or more sales target inputs a code, the server using the code to display a web page of the upgraded rep to the tagged sales target, the server displaying one or more web page to the tagged sales target where more that one upgraded rep tags the sales target, the server blocking access to the tagged sales target information by reps other than upgraded reps tagging the sales target for a designated period of time, the server notifying one or more upgraded rep when one or more sales target first accesses the network, wherein said first accessing sales target inputs an address in the sales target information, said address included in a territory inputted in the upgraded rep information;
17) the rep optionally disassociating with one or more associated sales target or associated related rep; and
18) the server logging and or archiving the offered and or accepted interaction and or appointment activity and optionally sorting and reporting the logged information.

34. A system of discovering other users in a network comprising:
a server with one or more computing component connected to a network, said server comprising a server database;
one or more sales target connected to the network and optionally connected to one or more related sales target through the network or through a second network, said sales target accessing the server through a security component, said security component comparing security information supplied by the sales target to sales target information contained in a sales target file stored in the server database, said sales target 1) inputting sales target information comprising general information and specific information, said specific information selected from the group personnel details, business affiliations, policies, and guidelines, said sales target information updateable and stored in the sales target file, and 2) using a search component to build a search using one of name, geographic and or demographic data to discover one or more rep and or one or more sales target connected to the network; and
one or more rep connected to the network and optionally connected to one or more related rep through the network or through a second network, said rep accessing the server through a security component, said security component comparing security information supplied by the rep to rep information contained in a rep file stored in the server database, said rep 1) inputting rep information comprising general information and specific information, said specific information selected from the group personnel details, business affiliations, policies, and guidelines, said rep information updateable and stored in the rep file, and 2) using a search component to build a search using one of name, geographic and or demographic data to discover one or more related rep and or one or more sales target.
